(19) United States
(12) Patent Application Publication
(10) Pub. No.: US 2008/0088052 A1
(43) Pub. Date: Apr. 17, 2008

(54) Method Of Producing A Resin Sheet

(75) Inventors: Katsuhiko Takada, Shizuoka (JP); Takekazu Yamamoto, Shizuoka (JP); Yasuyuki Hara, Shizuoka (JP); Takahiro Hayashi, Shizuoka (JP); Ryuichi Katsumoto, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/661,118

(22) PCT Filed: Aug. 22, 2005
(86) PCT No.: PCT/JP05/15583

§ 371 Date: Feb. 26, 2007

(30) Foreign Application Priority Data
Aug. 24, 2004 (JP) 2004-243384
Aug. 24, 2004 (JP) 2004-243389
Aug. 24, 2004 (JP) 2004-243385

(51) Int. Cl. B29C 59/06; B29C 47/24

(52) U.S. Cl. 264/145

(57) ABSTRACT

The present invention provides a method of producing a resin sheet, comprising the steps of: nipping a sheet-like resin material extruded from a die by a mold roller and a plurality of nip rollers placed to face the mold roller, transferring shapes of asperities on a surface of the mold roller to the resin material, and peeling the resin material after the transfer off from the mold roller by winding the resin material around a peeling roller placed to face the mold roller.

### TECHNICAL FIELD

The present invention relates to a method of producing a resin sheet, and more particularly to a method of producing a resin sheet suitable for use as a light guide plate or various optical elements placed on backsides of various display devices.

### BACKGROUND ART

As resin sheets used as various optical elements, Fresnel lenses or lenticular lenses have been used in various fields. Such resin sheets have regular shapes of asperities on surfaces thereof, and the shapes of the asperities provide optical performance as Fresnel lenses or lenticular lenses.

Various methods for producing such resin sheets have been proposed (see Japanese Patent Application Laid-Open No. 8-31025, Japanese Patent Application Laid-Open No. 7-314567, Japanese Patent Application Laid-Open No. 2003-53834, and Japanese Patent Application Laid-Open No. 8-287530). In all of these proposals, a roller molding method is used in view of improvement in productivity.

For example, in Japanese Patent Application Laid-Open No. 8-31025, improved cooling device is provided before peeling of a resin sheet from a roller to improve a transfer property. Japanese Patent Application Laid-Open No. 7-314567 discloses a method for producing a Fresnel lens by winding a mold around a roller.

In Japanese Patent Application Laid-Open No. 2003-53834, a heat buffering member is placed in a molding roller to improve productivity and a transfer property. In Japanese Patent Application Laid-Open No. 8-287530, corona discharge treatment is used to improve a transfer property and reduce defects.

A typical roller molding method of the conventional techniques has a configuration as shown in FIG. 12. The device configuration includes a die 2 for a sheet for molding a resin material 1 molten by an extruder (not shown) into a sheet, a stamper roller 3 having shapes of asperities on a surface thereof, a mirror finished roller 4 placed to face the stamper roller 3, and a mirror finished peeling roller 5 placed on the opposite side from the mirror finished roller 4.

The sheet-like resin material 1 extruded from the die 2 is nipped by the stamper roller 3 and the mirror finished roller 4, the shapes of the asperities on the surface of the stamper roller 3 are transferred to the resin material 1, and the resin material 1 is wound around the mirror finished peeling roller 5 and thus peeled off from the stamper roller 3.

### DISCLOSURE OF THE INVENTION

However, all the conventional proposals relate to a method of producing a relatively thin resin sheet, and are not suitable for production of a relatively thick resin sheet. Particularly, when a resin sheet having large thickness distribution along the width in molding is produced, a desired sectional shape is extremely hard to obtain.

For example, in roller molding of PMMA (polymethyl methacrylate resin) after extrusion, if thickness distribution is provided along the width, and a difference in thickness between the thickest portion and the thinnest portion is 1 mm or more, various problems occur such that unevenness occurs on a front surface or a back surface (shrinkage cavities caused by shrinkage during curing of the resin, or elastic recovery amount distribution), a rate of transfer of a surface shape is generally reduced, or a sharp edge shape cannot be transferred.

The present invention has been achieved in view of such circumstances, and has an object to provide a method of producing a resin sheet that is capable of obtaining a desired sectional shape when a resin sheet having large thickness distribution along the width in molding is produced, and suitable for use as a light guide plate or various optical elements placed on backsides of various display devices.

In order to achieve the above described object, a first aspect of the present invention provides a method of producing a resin sheet, comprising the steps of: nipping a sheet-like resin material extruded from a die by a mold roller and a plurality of nip rollers placed to face the mold roller, transferring shapes of asperities on a surface of the mold roller to the resin material, and peeling the resin material after the transfer off from the mold roller by winding the resin material around a peeling roller placed to face the mold roller.

According to the first aspect of the present invention, the sheet-like resin material is nipped by the mold roller and the plurality of nip rollers, the shapes of the asperities are transferred to the resin material, and the resin material is peeled off from the mold roller by winding the resin material around the peeling roller. Thus, by using the plurality of nip rollers placed to face the mold roller, if the resin sheet has large thickness distribution along the width in molding, and unevenness occurs on a back surface immediately after molding at a first nip point, the unevenness can be corrected, or the resin sheet can be quickly cooled and hardened to prevent deformation caused by downstream roll lapping (winding) and obtain a desired sectional shape.

In the first aspect, a difference in thickness between the thickest portion and the thinnest portion along the width of the resin material is preferably 1 mm or more with the shapes of the asperities transferred to the resin material. In the first aspect, the thickness of the thinnest portion of the resin material is preferably 5 mm or less. In this manner, an advantage of the present invention can be obtained in molding a resin material having a sectional shape that has been hard to mold.

In the first aspect, preferably, a belt-like member is provided between the mold roller and the plurality of nip rollers and/or the peeling roller, and the resin material is nipped by the belt-like member and the mold roller. Thus, by using the belt-like member, the resin material can be nipped in an increased distance to facilitate obtaining a desired sectional shape.

In order to achieve the above described object, a second aspect of the present invention provides a method of producing a resin sheet, comprising the steps of: nipping a sheet-like resin material extruded from a die by a mold roller and at least one nip roller placed to face the mold roller, transferring shapes of asperities on a surface of the mold roller to the resin material, and peeling the resin material after the transfer off from the mold roller by drawing the resin material in tangential direction of the mold roller and the nip roller.

According to the second aspect, the sheet-like resin material is nipped by the mold roller and at least one nip roller, and the shapes of the asperities are transferred to the resin material. The resin material after the transfer needs to be peeled off from the mold roller. Unlike the conventional technique, the resin material is not wound around the peeling roller and thus peeled off from the mold roller, but the resin material is drawn in tangential direction of the mold roller and the nip roller. In this case, with a plurality of nip rollers, the resin material is drawn in tangential direction of the mold roller and a nip roller placed in the most downstream position (the most downstream position in a conveying direction of the resin material). Thus, flatness of the resin material peeled off from the mold roller can be maintained, and thus the resin material can be peeled off from the mold roller without deforming the shapes of the asperities transferred to the resin material by the mold roller. This allows the resin sheet having a desired sectional shape to be produced.

If the resin material is wound around the peeling roller and thus peeled off as in the conventional techniques, the winding causes the resin material peeled off from the mold roller to lose flatness, which tends to deform the transferred shapes of the asperities.

In order to achieve the above described object, a third aspect of the present invention provides a method of producing a resin sheet, comprising the steps of: nipping a sheet-like resin material extruded from a die by a mold roller and a belt-like member provided between the mold roller and a plurality of press rollers placed to face the mold roller, transferring shapes of asperities on a surface of the mold roller to the resin material, and peeling the resin material after the transfer off from the mold roller by drawing the resin material in tangential direction of the mold roller and a press roller placed in the most downstream position among the plurality of press rollers.

As in the third aspect of the present invention, by using the belt-like member, the resin material can be nipped in an increased distance to facilitate obtaining a desired sectional shape.

In the second or the third aspects of the present invention, it is preferable that a temperature of the resin material at a peeling point from the mold roller is a softening point (Ta) or less of the resin material. This is because when the resin material is peeled off from the mold roller by drawing the resin material in tangential direction, the resin material immediately after the peeling is not supported in the air, and the resin material itself tends to be deformed at the softening point (Ta) or more, which may cause deformation of the shape of the asperity pattern of the peeled resin material with a free surface.

In this case, when the resin material is nipped by the mold roller and at least one nip roller, and the shapes of the asperities of the mold roller are transferred to the resin material, as in the second aspect of the present invention, device for cooling the resin material during the transfer such as an air nozzle is preferably provided. When the belt-like member is provided as in the third aspect of the present invention, device for cooling the belt-like member is preferably provided to cool the resin material from a back surface (a surface opposite from the surface in contact with the mold roller) of the resin material.

In the second or the third aspects, it is preferable that the resin material is slowly cooled in a slow cooling zone while being conveyed in the tangential direction of drawing. This is because even if the resin material peeled off from the mold roller has the flatness, the resin material preferably maintains the flatness until the resin material is cooled and hardened and the transferred shapes of the asperities are completely fixed, in terms of obtaining a resin sheet having a desired sectional shape.

In order to achieve the above described object, a fourth aspect of the present invention provides a method of producing a resin sheet, comprising the steps of: nipping a sheet-like resin material extruded from a die by a mold roller and at least one nip roller placed to face the mold roller, transferring shapes of asperities on a surface of the mold roller to the resin material, and peeling the resin material after the transfer off from the mold roller by winding the resin material around a peeling roller placed to face the mold roller and having a large diameter of 500 mm or more that is twice or more a diameter of the mold roller.

According to the fourth aspect, the peeling roller is used as in the conventional techniques, and the peeling roller has the large diameter of 500 mm or more that is twice or more the diameter of the mold roller. The use of the peeling roller, having the large diameter allows the resin material to be drawn substantially in tangential direction of the mold roller as in the second or the third aspect of the present invention, facilitates obtaining flatness of the resin material.

In any one of the second to the fourth aspects, it is preferable that a difference in thickness between the thickest portion and the thinnest portion along the width of the resin material is 1 mm or more with the shapes of the asperities transferred to the resin material. In the first to the fourth aspects, the thickness of the thinnest portion of the resin material is preferably 5 mm or less. In this manner, an advantage of the present invention can be further provided in molding a resin material having a sectional shape that has been hard to mold.

In order to achieve the above described object, a fifth aspect of the present invention provides a method of producing a resin sheet, comprising the steps of: nipping a sheet-like resin material extruded from a die by a first mold roller and a first nip roller placed to face the first mold roller, transferring shapes of asperities on a surface of the first mold roller to the resin material, peeling the resin material after the transfer off from the first mold roller by winding the resin material around a peeling roller placed to face the first mold roller, nipping the resin material after the peeling by a second mold roller and a second nip roller placed to face the second mold roller, and transferring shapes of asperities on a surface of the second mold roller to the resin material.

According to the fifth aspect, it is preferable that the sheet-like resin material is nipped by the first mold roller and the first nip roller, the shapes of the asperities are transferred to the resin material, and the resin material is peeled off from the first mold roller. Then, the resin material is nipped by the second mold roller and the second nip roller, and the shapes of the asperities are transferred to the resin material. Thus, the use of the plurality of sets of the mold rollers and the nip rollers allows even a resin sheet having large thickness distribution along the width in molding to obtain a desired sectional shape by gradually bringing the shape close to a design shape.

In the fifth aspect, it is preferable that lapping angles of the resin material wound around the second mold roller and the second nip roller are both less than 5 degrees. In such a state, the resin material is nipped by the second mold roller and the second nip roller to allow the flat-sheet-like resin material to be conveyed without being bent.

In the fifth aspect, it is preferable that at least one set of a mold roller and a nip roller having the same configurations as the second mold roller and the second nip roller are provided on a downstream side in a traveling direction of the resin material of the second mold roller and the second nip roller to gradually bring the shapes of the asperities transferred to the resin material close to design shapes. A certain level of advantages can be obtained by one set of the second mold roller and the second nip roller, but greater advantages of the present invention can be obtained by providing the plurality of sets for gradual machining.

A sixth aspect of the present invention provides a method of producing a resin sheet, comprising the steps of: nipping a sheet-like resin material extruded from a die by a first front mold roller and a first back mold roller placed to face the first front mold roller, transferring shapes of asperities on a surface of the first front mold roller and shapes of asperities on a surface of the first back mold roller to the resin material, peeling the resin material after the transfer off from the first front mold roller by winding the resin material around a separation roller placed to face the first front mold roller, nipping the resin material after the separation by a second front mold roller and a second back mold roller placed to face the second front mold roller, and transferring shapes of asperities on a surface of the second front mold roller and shapes of asperities on a surface of the second back mold roller to the resin material.

According to the sixth aspect, in forming the shapes of the asperities on front and back surfaces of the resin material, the shapes are transferred by the pair of first roller sets and then by the pair of second roller sets. This allows even a resin sheet having large thickness distribution along the width in molding to obtain a desired sectional shape by gradually bringing the shape close to a design shape.

In the sixth aspect, it is preferable that lapping angles of the resin material wound around the second front mold roller and the second back mold roller are both less than 5 degrees. In such a state, the resin material is nipped by the second front mold roller and the second back mold roller to allow the flat-sheet-like resin material to be conveyed without being bent.

In the sixth aspect, it is preferable that at least one set of a front mold roller and a back mold roller having the same configurations as the second front mold roller and the second back mold roller are provided on a downstream side in a traveling direction of the resin material of the second front mold roller and the second back mold roller to gradually bring the shapes of the asperities transferred to the resin material close to design shapes. A certain level of advantages can be obtained by one set of the second front mold roller and the second back mold roller, but greater advantages of the present invention can be obtained by providing the plurality of sets for gradual machining.

In the sixth aspect, it is preferable that the shapes of the asperities substantially the same as the shapes of the asperities on the surface of the first back mold roller are formed on a surface of the separation roller. The peeling roller having the shapes of the asperities can transfer the shapes in cooperation with the first front mold roller, and thus greater advantages of the present invention can be obtained.

An seventh aspect of the present invention provides a method of producing a resin sheet, comprising the steps of: nipping a sheet-like resin material extruded from a die by a first mirror finished roller and a second mirror finished roller placed to face the first mirror finished roller, molding the resin material to have a predetermined thickness, peeling the resin material after the molding off from the first mirror finished roller by winding the resin material around a peeling roller placed to face the first mirror finished roller, nipping the resin material after the peeling by a mold roller and a nip roller placed to face the mold roller, and transferring shapes of asperities on a surface of the mold roller to the resin material.

According to the seventh aspect, the flat-sheet-like resin material after the peeling from the first mirror finished roller is subjected to the transfer by the mold roller and the nip roller. This allows a desired sectional shape to be obtained, and facilitates maintaining flatness of the resin material.

In the seventh aspect, it is preferable that lapping angles of the resin material wound around the mold roller and the nip roller are both less than 5 degrees. In such a state, the resin material is nipped by the mold roller and the nip roller to allow the flat-sheet-like resin material to be conveyed without being bent.

In the seventh aspect, it is preferable that a plurality of sets of the mold rollers and the nip rollers are provided to gradually bring the shapes of the asperities transferred to the resin material close to design shapes. A certain level of advantages can be obtained by one set of the mold roller and the nip roller, but greater advantages of the present invention can be obtained by providing the plurality of sets for gradual machining.

In the seventh aspect, it is preferable that a difference in thickness between the thickest portion and the thinnest portion along the width of the resin material is 1 mm or more with the shapes of the asperities transferred to the resin material.

In the seventh aspect, it is preferable that the thickness of the thinnest portion of the resin material is 5 mm or less. In this manner, an advantage of the present invention can be obtained in molding a resin material having a sectional shape that has been hard to mold.

As described above, according to the present invention, even a resin sheet having large thickness distribution along the width in molding can obtain a desired sectional shape. The resin sheet produced by the present invention is suitable for use as a light guide plate or various optical elements placed on backsides of various display devices.

### BRIEF DESCRIPTION OF THE DRAWINGS

FIG. 1 is a configuration view of an example of a production line of a resin sheet to which the present invention is applied;

FIG. 2 is a perspective view of a resin material after molding with an end surface thereof being linearly cut;

FIG. 3 is a perspective view of a resin material after molding with an end surface thereof being linearly cut;

FIG. 4 is a configuration view of another example of a production line of a resin sheet to which the present invention is applied;

FIG. 5 is a configuration view of a further example of a production line of a resin sheet to which the present invention is applied;

FIG. 6 is a configuration view of a further example of a production line of a resin sheet to which the present invention is applied;

FIG. 7 is a configuration view of a further example of a production line of a resin sheet to which the present invention is applied;

FIG. 8 is a configuration view of a further example of a production line of a resin sheet to which the present invention is applied;

FIGS. 9A to 9E are sectional views of a resin material in respective molding steps;

FIG. 10 is a configuration view of a further example of a production line of a resin sheet to which the present invention is applied;

FIG. 11 is a configuration view of a further example of a production line of a resin sheet to which the present invention is applied; and

FIG. 12 is a configuration view of a production line of a resin sheet according to a conventional example.

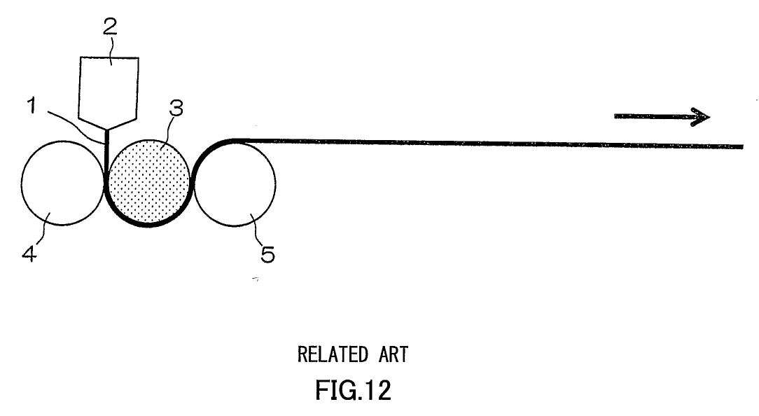

### DESCRIPTION OF SYMBOLS

10 production line of resin sheet
12 die
14 resin material
16 mold roller
18 first nip roller
20 second nip roller
22 third nip roller
24 peeling roller
26, 28 cooling device
30 slow cooling zone

### BEST MODE FOR CARRYING OUT THE INVENTION

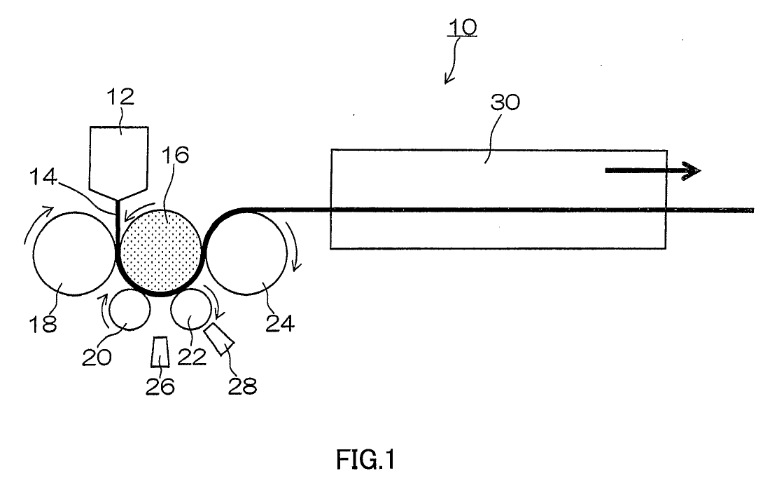

Now, a preferable embodiment (a first embodiment) of a method of producing according to the present invention will be described in detail with reference to the accompanying drawings. FIG. 1 is a configuration view of an example of a production line of a resin sheet to which the method of producing a resin sheet according to the present invention is applied.

A production line 10 of the resin sheet includes a die 12 for a sheet for molding a resin material 14 molten by an extruder (not shown) into a sheet, a mold roller 16 having shapes of asperities on a surface thereof, a plurality of nip rollers (a first nip roller 18, a second nip roller 20 and a third nip roller 22) placed to face the mold roller 16, a peeling roller 24 placed to face the mold roller 16, cooling devices 26 and 28, and a slow cooling zone 30.

A slit size of the die 12 is formed so that a width of the molded molten resin material 14 is larger than a width of the mold roller 16, and the die 12 is placed so that the molten resin material 14 extruded from the die 12 is extruded out between the mold roller 16 and the first nip roller 18.

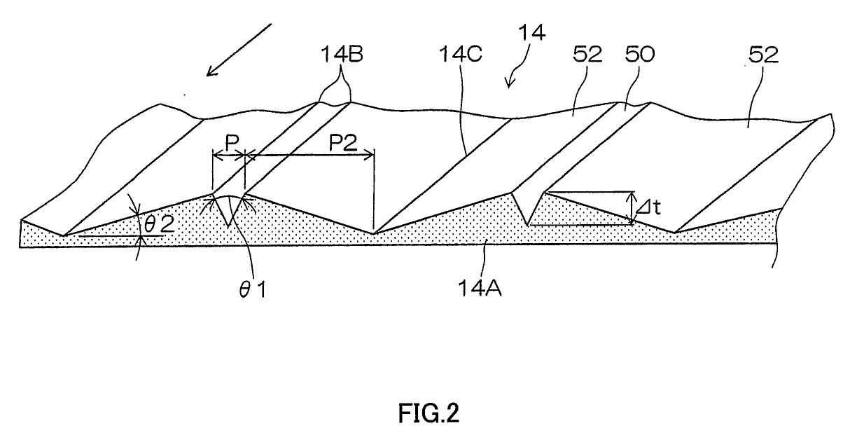

The mold roller 16 has regular shapes of asperities on a surface thereof. The regular shapes of the asperities may be, for example, inverted shapes of the resin material 14 after the molding as shown in FIG. 2. FIG. 2 is a perspective view of the resin material 14 after molding with an end surface 14A thereof being linearly cut.

Specifically, a back surface of the resin material 14 is flat, and a linear asperity pattern parallel to the arrow is formed on a surface of the resin material 14. The arrow shows a traveling direction of the resin material 14. Thus, endless grooves of the inverted shapes on the end surface 14A may be formed on the surface of the mold roller 16. Details on a shape of the asperity pattern on the surface of the resin material 14 will be described later.

As a material of the mold roller 16, various steel members, stainless steel, copper, zinc, brass, these metal materials used as core bars with surfaces lined with rubber, these metal materials plated with Hcr, Cu or Ni, ceramics, and various composite materials may be used.

As a forming method of the asperity pattern on the surface of the mold roller 16, a combination of cutting by an NC lathe and buffing is generally preferably used, depending on an asperity pattern (a pitch, a depth, or the like) or a material of the surface of the mold roller 16. Other known machining methods (grinding, ultrasonic machining, or electrical discharge machining, or the like) may be used.

Surface roughness (Ra) of the mold roller 16 is preferably 0.5 μm or less, more preferably 0.2 μm or less.

The mold roller 16 is rotatably driven by unshown drive device at a predetermined circumferential velocity in the direction of arrow in FIG. 1. The mold roller 16 also has temperature adjusting device. Such temperature adjusting device is provided to control to prevent a temperature increase of the mold roller 16 caused by the hot resin material 14 or a sudden temperature decrease thereof.

As such temperature adjusting device, a configuration of circulating oil with an adjusted temperature in the roller is preferably used. Supply and discharge of the oil may be achieved by a configuration having a rotary joint at an end of the roller. This temperature adjusting device is used in the production line 10 of the resin sheet in FIG. 1.

The nip rollers are rollers that are placed to face the mold roller 16 and nip the resin material 14 in cooperation with the mold roller 16, and placed in the order of the first nip roller 18, the second nip roller 20, and the third nip roller 22 from an upstream side in the traveling direction.

Surfaces of the nip rollers 18, 20 and 22 are preferably mirror finished. Such surfaces allow a satisfactory state of the back surface of the resin material 14 after the molding. Surface roughness (Ra) of the nip rollers 18, 20 and 22 is preferably 0.5 μm or less, more preferably 0.2 μm or less.

As materials of the nip rollers 18, 20 and 22, various steel members, stainless steel, copper, zinc, brass, these metal materials used as core bars with surfaces lined with rubber, these metal materials plated with Hcr, Cu or Ni, ceramics, and various composite materials may be used.

The nip rollers 18, 20 and 22 are rotatably driven by unshown drive device at a predetermined circumferential velocity in the direction of arrow in FIG. 1. A configuration such that no drive device is provided in the nip rollers 18, 20 and 22 may be allowed, but providing the drive device is preferable for obtaining a satisfactory state of the back surface of the resin material 14.

When the drive device is provided in the nip rollers 18, 20 and 22, a configuration having varying drive velocities is preferably used. Thus, an operation method may be used of gradually increasing the velocities (at most within a few percent) in the order of the nip rollers 18, 20 and 22 to be faster than the circumferential velocity of the mold roller 16.

The nip rollers 18, 20 and 22 each have unshown pressurizing device so as to be able to nip the resin material 14 in cooperation with the mold roller 16 with predetermined pressure. The pressurizing device has a configuration of applying pressure in the direction of the normal to contact points between the nip rollers 18, 20 and 22 and the mold roller 16, and various known device such as motor drive device, an air cylinder, or a hydraulic cylinder may be used.

The nip rollers 18, 20 and 22 each may have a configuration that prevents bending caused by a reaction of a pressurizing force. Such a configuration includes a configuration with a backup roller provided on back surface sides (sides opposite from the mold roller 16) of the nip rollers 18, 20 and 22, a configuration using a crowned shape, a configuration with rollers having strength distribution to increase rigidity at axial centers of the rollers, and a configuration with a combination thereof.

The nip rollers 18, 20 and 22 each have the temperature adjusting device. For set temperatures of the first nip roller 18, the second nip roller 20, and the third nip roller 22, optimum values need to be selected depending on a material of the resin material 14, a temperature at melting (for example, a slit outlet of the die 12) of the resin material 14, a conveying velocity of the resin material 14, an outer diameter of the mold roller 16, a shape of an asperity pattern of the mold roller 16, or the like.

As the temperature adjusting device of each of the first nip roller 18, the second nip roller 20, and the third nip roller 22, a configuration of circulating oil with an adjusted temperature in the roller is preferably used. Supply and discharge of the oil may be achieved by a configuration having a rotary joint at an end of the roller. This temperature adjusting device is used in the production line 10 of the resin sheet in FIG. 1.

As other temperature adjusting device, various known device may be used such as a configuration with a sheath heater incorporated into the roller or a configuration with dielectric heating device provided near the roller.

Further, in the production line 10 of the resin sheet in FIG. 1, the cooling devices 26 and 28 are provided to assist the temperature adjusting device of the first nip roller 18, the second nip roller 20, and the third nip roller 22.

The cooling devices 26 and 28 are both air nozzles. The air nozzle of the cooling device 26 is placed so as to blow air on the resin material 14 that is being conveyed from a gap between the second nip roller 20 and the third nip roller 22, and the air nozzle of the cooling device 28 is placed so as to blow air on the third nip roller 22. Thus, the temperature of the resin material 14 may be controlled directly and also via the third nip roller 22.

For temperatures and the amount of supply (the amount of blowing flow) of the air of the cooling devices 26 and 28, optimum values need to be selected depending on the material of the resin material 14, the temperature at melting (for example, the slit outlet of the die 12) of the resin material 14, the conveying velocity of the resin material 14, the outer diameter of the mold roller 16, the shape of the asperity pattern of the mold roller 16, the set temperatures of the nip rollers (the first nip roller 18, the second nip roller 20, and the third nip roller 22), or the like.

The peeling roller 24 is a roller that is placed to face the mold roller 16 and peels the resin material 14 off from the mold roller 16 by the resin material 14 being wound around the peeling roller 24, and is placed on a downstream side 180° away from the first nip roller 18 via the mold roller 16.

A surface of the peeling roller 24 is preferably mirror finished. Such a surface allows a satisfactory state of the back surface of the resin material 14 after the molding. Surface roughness (Ra) of the peeling roller 24 is preferably 0.5 μm or less, more preferably 0.2 μm or less.

As a material of the peeling roller 24, various steel members, stainless steel, copper, zinc, brass, these metal materials used as core bars with surfaces lined with rubber, these metal materials plated with Hcr, Cu or Ni, ceramics, and various composite materials may be used.

The peeling roller 24 is rotatably driven by unshown drive device at a predetermined circumferential velocity in the direction of arrow in FIG. 1. A configuration such that no drive device is provided in the peeling roller 24 may be allowed, but providing the drive device is preferable for obtaining a satisfactory state of the back surface of the resin material 14.

The peeling roller 24 has temperature adjusting device. Adjusting the peeling roller 24 to a proper set temperature allows a satisfactory shape of the asperity pattern on the surface of the resin material 14.

In order to monitor a surface temperature of each spot on the rollers and the resin material 14, surface temperature measuring device (not shown) is preferably provided. As such surface temperature measuring device, various known measuring device may be used such as an infrared thermometer or a radiation thermometer.

As spots measured by the surface temperature measuring device, a plurality of points along the width of the resin material 14 between the die 12 and the first nip roller 18, a plurality of points along the width of the resin material 14 immediately after the peeling roller 24, surfaces (surfaces opposite from the rollers) of a plurality of points along the width of the resin material 14 wound around the mold roller 16 or the peeling roller 24 are considered.

Monitoring results of the surface temperature measuring device may be fed back to the temperature adjusting device of each roller or the die 12 or the like to be reflected on the temperature control of each roller or the like. An operation by feed forward control may be allowed without providing the surface temperature measuring device.

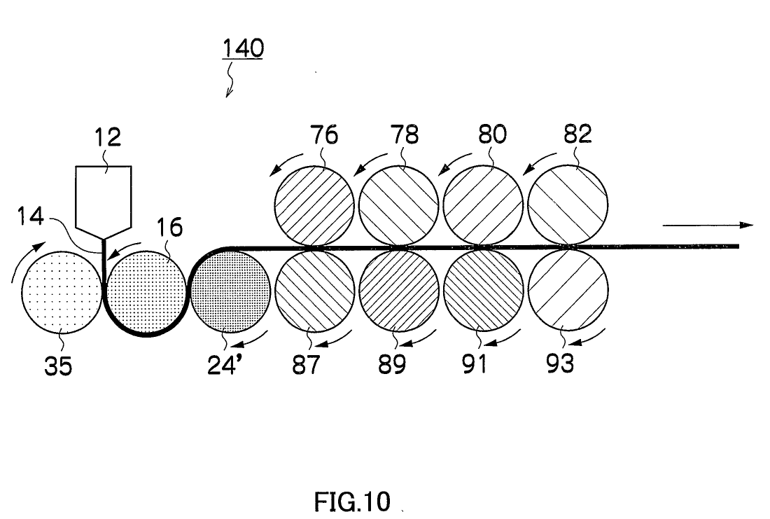

Tension detecting device for detecting tension of the resin material 14 or thickness detecting device (a thickness sensor) for detecting a thickness of the resin material 14 may be preferably provided on the production line 10 of the resin sheet in FIG. 10 or on a downstream side thereof. Detection results by the detecting device may be compared to set values and fed back to draw control described later.

The slow cooling zone 30 (or an annealing zone) is provided to prevent sudden temperature changes of the resin material 14 on the downstream side of the peeling roller 24. When a sudden temperature change occur in the resin material 14, for example, the resin material 14 is plastic near the surface but elastic inside, and shrinkage caused by curing of the inside degrades the shape of the surface of the resin material 14. A temperature difference also occurs between the front and back surfaces of the resin material 14 to cause warpage in the resin material 14.

As the slow cooling zone 30, a configuration of a horizontal tunnel shape may be used that has temperature adjusting device in the tunnel and can control a cooling temperature profile of the resin material 14. As the temperature adjusting device, various known device may be used such as a configuration of blowing air with a controlled temperature (hot air or cold air) toward the resin material 14 with a plurality of nozzles, or a configuration of heating the front and back surfaces of the resin material 14 with heating device (a nichrome heater, an infrared heater, dielectric heating device, or the like).

On a downstream side of the slow cooling zone 30 (or the annealing zone), a cleaning device (a cleaning zone), a defect testing device (a testing zone), a laminating device, a side cutter, a cross cutter, and a stacking portion are provided in this order.

The laminating device is a device for sticking a protective film (a film made of polyethylene or the like) on the front and back surfaces of the resin material 14, the side cutter is a device for cutting both ends (waste portions) along the width of the resin material 14, and the cross cutter is a device for trimming the resin material 14 to a predetermined length.

Among the above described devices, some devices may be omitted according to use.

Next, the method of producing a resin sheet using the production line 10 of the resin sheet in FIG. 1 will be described.

As the resin material 14 applied to the present invention, thermoplastic resin may be used including, for example, polymethyl methacrylate resin (PMMA), polycarbonate resin, polystyrene resin, MS resin, AS resin, polypropylene resin, polyethylene resin, polyethylene terephthalate resin, polyvinyl chloride (PVC), thermoplastic elastomer, copolymers thereof, cycloolefin polymer, or the like.

The sheet-like resin material 14 extruded from the die 12 is nipped by the mold roller 16 and the plurality of nip rollers (the first nip roller 18, the second nip roller 20, and the third nip roller 22) placed to face the mold roller 16, the shapes of the asperities on the surface of the mold roller 16 are transferred to the resin material 14, and the resin material 14 is wound around the peeling roller 24 placed to face the mold roller 16 and thus peeled off from the mold roller 16.

The resin material 14 peeled off from the mold roller 16 is conveyed in the horizontal direction, passed through the slow cooling zone 30 and thus slowly cooled. Then, the resin material 14 with deformation being removed is cut into a predetermined length in a product taking portion downstream and housed as resin sheet products.

In producing the resin sheet, an extruding velocity of the resin material 14 from the die 12 may be 0.1 to 50 m/min, preferably 0.3 to 30 m/min. Thus, the circumferential velocity of the mold roller 16 is substantially matched with the extruding velocity.

On the other hand, the nip rollers (the first nip roller 18, the second nip roller 20, and the third nip roller 22) are driven by an operation method of so-called draw control such that velocities are gradually increased in the order of the nip rollers 18, 20 and 22 to be faster than the circumferential velocity of the mold roller 16. A draw value between the nip rollers 18, 20 and 22 is preferably 0 to 3%, more preferably 0 to 1%.

Uneven velocity of each roller is preferably controlled to be within 1% of a set value.

Pressing pressure of each nip roller (the first nip roller 18, the second nip roller 20, and the third nip roller 22) on the mold roller 16 is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

The temperatures of the nip rollers 18, 20 and 22 and the peeling roller 24 are preferably controlled individually. Then, the temperature of the resin material 14 at a spot of the peeling roller 24 is preferably a softening point Ta or less of the resin. In this respect, when polymethyl methacrylate resin is used as the resin material 14, a set temperature of the peeling roller 24 may be 50 to 110° C.

Next, details of the shape of the asperity pattern on the surface of the resin material 14 will be described. As described above, FIG. 2 is a perspective view of the resin material 14 after molding with the end surface 14A thereof being linearly cut. The back surface of the resin material 14 is flat.

The shape of the asperity pattern on the surface of the resin material 14 is the linear asperity pattern in a longitudinal direction (the direction of arrow in the figure). This pattern includes alternate V grooves 50 formed in thickest portions 14B of the resin material 14 and taper portions 52 and 52 having a thickness linearly decreasing from both edge of each V groove 50 toward thinnest portions 14C of the resin material 14. Specifically, the pattern has a continuous shape with the V groove 50 and the taper portions 52 and 52 in line symmetry with respect to a center line of the V groove 50, as one unit (one pitch).

In FIG. 2, the thickness of the thinnest portion 14C of the resin material 14 is preferably 5 mm or less, more preferably 2 mm or less. A difference in thickness between the thickest portion 14B and the thinnest portion 14C of the resin material 14 is preferably 1 mm or more, more preferably 2.5 mm or more. Such a dimension allows the resin material 14 to be suitably used as a light guide plate or various optical elements placed on backsides of various display devices.

When the resin material 14 after the molding is used as a light guide plate, a cylindrical cold cathode tube is placed in the V groove 50, and light emitted from the cold cathode tube is incident on the inside of the resin material 14 from the surface of the V groove 50, reflected by the taper portions 52 and 52, and applied from the back surface of the resin material 14 in a sheet shape.

Thus, when the resin material 14 after the molding is used as the light guide plate, a width p of the V groove 50 is preferably 2 mm or more, and a vertical angle θ1 of the V groove 50 is preferably 40 to 80 degrees. A depth Δt of the V groove 50 is preferably 1 mm or more, more preferably 2.5 mm or more. An inclination angle θ2 of the taper portions 52 and 52 is preferably 3 to 20 degrees. A width p2 of the taper portions 52 and 52 is preferably 5 mm or more, more preferably 10 mm or more.

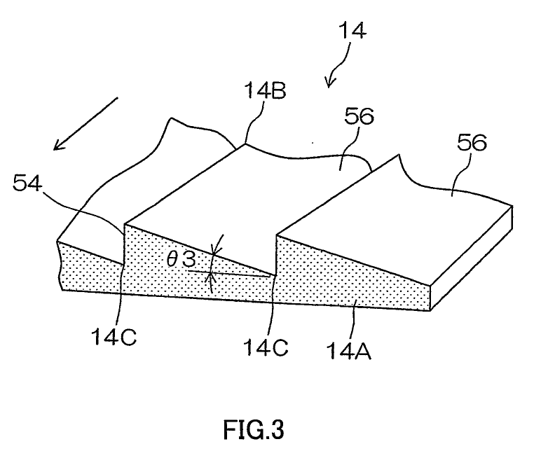

Next, another shape of an asperity pattern on a surface of a resin material 14 will be described. FIG. 3 is a perspective view of a resin material 14 after molding with an end surface 14A being linearly cut. A back surface of the resin material 14 is flat.

A shape of an asperity pattern on a surface of the resin material 14 is a linear asperity pattern in a longitudinal direction (the direction of arrow in the figure). This pattern having a serrated section includes alternate vertical walls 54 connecting thickest portions 14B and thinnest portions 14C of the resin material 14 and taper portions 56 having thicknesses linearly decreasing from upper edges (thickest portions 14B) of the vertical walls 54 toward the thinnest portions 14C of the resin material 14.

In FIG. 3, the thickness of the thinnest portion 14C of the resin material 14 is preferably 5 mm or less, more preferably 2 mm or less. A difference in thickness between the thickest portion 14B and the thinnest portion 14C of the resin material 14 is preferably 1 mm or more, more preferably 2.5 mm or more. Such a dimension allows the resin material 14 to be suitably used as a light guide plate or various optical elements placed on backsides of various display devices.

When the resin material 14 after the molding is used as a light guide plate, a cylindrical cold cathode tube is placed on a side surface of the vertical wall 54, and light emitted from the cold cathode tube is incident on the inside of the resin material 14 from the surface (side surface) of the vertical wall 54, reflected by the taper portion 56, and applied from the back surface of the resin material 14 in a sheet shape.

Thus, when the resin material 14 after the molding is used as the light guide plate, an inclination angle θ3 of the taper portion 56 is preferably 3 to 20 degrees.

When the resin material 14 after the molding is used in the light guide plate, other shapes may be used. For example, the V groove 50 in the resin material 14 in FIG. 2 has a V-shaped section, but sections of other shapes such as rectangular, trapezoidal, arcuate, or parabolic sections may be used if they meet optical properties or moldability.

The shapes of the asperities on the surface of the mold roller 16 need not be the inverted shapes of the resin material 14 in FIG. 2 or 3, but may be offset from the inverted shapes so that a product shape of the resin material 14 is as shown in FIG. 2 or 3 in view of margin for shrinkage of the resin material 14.

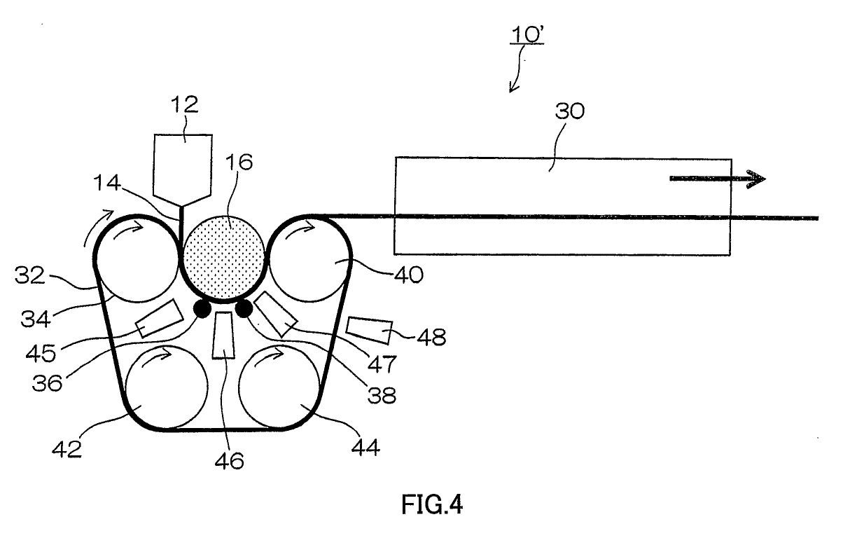

Next, another embodiment (a second embodiment) of a method of producing a resin sheet according to the present invention will be described in detail. FIG. 4 is a configuration view of a production line 10′ of a resin sheet to which the method of producing a resin sheet according to the present invention is applied. The same or similar members as in the first embodiment in FIG. 1 will be denoted by the same reference numerals, and descriptions thereof will be omitted.

In the embodiment, instead of the nip rollers (the first nip roller 18, the second nip roller 20, and the third nip roller 22) and the peeling roller 24 in the first embodiment, a nip belt 32, a plurality of press rollers 34, 36, 38 and 40, and guide rollers 42 and 44 are used.

In the production line 10′ of the resin sheet, the first press roller 34, the second press roller 36, the third press roller 38, and the fourth press roller 40 are placed in positions corresponding to the first nip roller 18, the second nip roller 20, the third nip roller 22, and the peeling roller 24 in the production line 10 of the resin sheet (the first embodiment), and have substantially the same functions.

However, a resin material 14 is nipped by the nip belt 32 that is an endless belt and a mold roller 16, which increases a distance of the resin material 14 being nipped to facilitate obtaining a desired sectional shape.

A surface of the nip belt 32 is preferably mirror finished. Such a surface allows a satisfactory state of a back surface of the resin material 14 after molding. Surface roughness (Ra) of the nip belt 32 is preferably 0.5 μm or less, more preferably 0.2 μm or less.

As a material of the nip belt 32, various steel members, stainless steel, these metal materials with surfaces lined with rubber, these metal materials plated with Hcr, Cu or Ni, ceramics, and various composite materials may be used.

As described above, the press rollers 34, 36, 38 and 40 have the same functions as the nip rollers in the first embodiment, and thus various configurations of the press rollers may be the same as those of the nip rollers in the first embodiment, such as a configuration with drive device, a configuration with pressurizing device, a configuration with temperature adjusting device, or a configuration that prevents bending caused by a reaction of pressure.

However, the press rollers 34, 36, 38 and 40 do not come into direct contact with the resin material 14 after the molding, and thus finished states of surfaces of the press rollers 34, 36, 38 and 40 may be poorer than those of the nip rollers in the first embodiment.

The nip belt 32 moves at a uniform velocity, which eliminates the need for a configuration corresponding to the operation method of so-called draw control in the first embodiment. If the nip belt 32 moves at a uniform velocity, not all the press rollers 34, 36, 38 and 40 and the guide rollers 42 and 44 may have drive device.

The guide rollers 42 and 44 require a function of allowing conveyance of the nip belt 32 at a uniform velocity (drive device), and a function of providing predetermined tension to the nip belt 32 to prevent slips between the nip belt 32 and the press rollers 34, 36, 38 and 40 (tension adjusting device).

The tension adjusting device may have the same configuration as the pressurizing device provided in each nip roller in the first embodiment. The tension adjusting device may be provided in one of the guide rollers 42 and 44.

In the production line 10′ of the resin sheet in FIG. 4, cooling devices 45, 46, 47 and 48 are provided as in the first embodiment, and have temperature adjusting functions of the nip belt 32. The cooling devices 45, 46, 47 and 48 may have the same configurations as the cooling devices 26 and 28 in the first embodiment.

Next, the method of producing a resin sheet using the production line 10′ of the resin sheet in FIG. 4 will be described.

The sheet-like resin material 14 extruded from the die 12 is nipped by the mold roller 16 and the nip belt 32 placed to face the mold roller 16, shapes of asperities on the surface of the mold roller 16 are transferred to the resin material 14, and the resin material 14 is peeled off from the mold roller 16 at a position of the press roller 40.

The resin material 14 peeled off from the mold roller 16 is conveyed in the horizontal direction, passed through a slow cooling zone 30 and thus slowly cooled. Then, the resin material 14 with deformation being removed is cut into a predetermined length in a product taking portion downstream and housed as resin sheet products.

In producing the resin sheet, an extruding velocity of the resin material 14 from the die 12 may be 0.1 to 50 m/min, preferably 0.3 to 30 m/min. Thus, the circumferential velocities of the mold roller 16 and the nip belt 32 are substantially matched with the extruding velocity.

Pressing pressure of each press roller (the first press roller 34, the second press roller 36, the third press roller 38, and the fourth press roller 40) on the mold roller 16 is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

The tension of the nip belt 32 by the tension adjusting device (the guide roller 42 or 44) is more preferably 0.1 to 100 kN/m (0.1 to 100 kgf/cm).

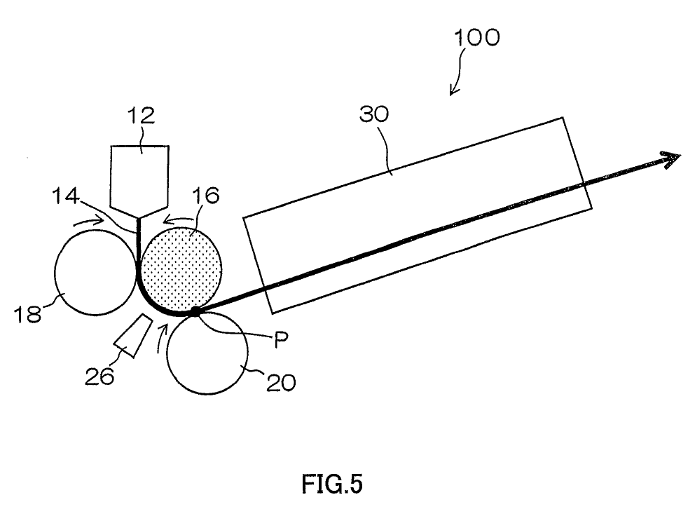

Next, a further embodiment (a third embodiment) of a method of producing a resin sheet according to the present invention will be described in detail with reference to the accompanying drawings. FIG. 5 is a configuration view of a production line of a resin sheet to which the method of producing a resin sheet according to the present invention is applied.

A production line 100 of the resin sheet includes a die 12 for a sheet for molding a resin material 14 molten by an extruder (not shown) into a sheet, a mold roller 16 having shapes of asperities on a surface thereof, a plurality of nip rollers (a first nip roller 18 and a second nip roller 20) placed to face the mold roller 16, a cooling device 26, and a slow cooling zone 30 (or an annealing zone (a correcting zone of warpage caused by single sided heating or the like)).

A slit size of the die 12 is formed so that a width of the molded molten resin material 14 is larger than a width of the mold roller 16, and the die 12 is placed so that the molten resin material 14 extruded from the die 12 is extruded out between the mold roller 16 and the first nip roller 18.

The mold roller 16 has regular shapes of asperities on a surface thereof. The regular shapes of the asperities may be, for example, inverted shapes of the resin material 14 after the molding as shown in FIG. 2.

Specifically, a back surface of the resin material 14 is flat, and a linear asperity pattern parallel to the arrow is formed on a surface of the resin material 14. The arrow shows a traveling (conveying) direction of the resin material 14. Thus, endless grooves of the inverted shapes on the end surface 14A may be formed on the surface of the mold roller 16. Details on a shape of the asperity pattern on the surface of the resin material 14 are as described above.

A material of the mold roller 16, a forming method of the asperity pattern on the surface of the mold roller 16, surface roughness of the mold roller 16, rotatable driving of the mold roller 16, temperature adjusting device of the mold roller 16, or the like are the same as in the first embodiment, and descriptions thereof will be omitted.

The nip rollers are rollers that are placed to face the mold roller 16 and nip the resin material 14 in cooperation with the mold roller 16, and placed in the order of the first nip roller 18 and the second nip roller 20 from an upstream side in the traveling direction.

Surface states (surface roughness, or the like) of the nip rollers 18 and 20, materials of the nip rollers 18 and 20, rotatable driving of the nip rollers 18 and 20, pressurizing device of the nip rollers 18 and 20, measures against bending of the nip rollers 18 and 20, temperature adjusting device of the nip rollers 18 and 20, or the like are the same as in the first embodiment, and descriptions thereof will be omitted.

In temperature adjustment of the nip rollers 18 and 20, too low a set temperature of the first nip roller 18 causes sudden cooling of the molten resin material 14, thereby unpreferably causing deformation in the resin material 14. Too high a set temperature of the second nip roller 20 causes the resin material 14 to be peeled off from the mold roller 16, which unpreferably causes deformation of the shape of the asperity pattern after the surface of the resin material 14 becomes free.

For set temperatures of the mold roller 16, the first nip roller 18, and the second nip roller 20, optimum values need to be selected depending on a material of the resin material 14, a temperature at melting (for example, a slit outlet of the die 12) of the resin material 14, a conveying velocity of the resin material 14, an outer diameter of the mold roller 16, the shape of the asperity pattern of the mold roller 16, or the like.

Further, in the production line 100 of the resin sheet in FIG. 5, the cooling device 26 is provided to assist the temperature adjusting device of the first nip roller 18 and the second nip roller 20.

The cooling device 26 is an air nozzle. The air nozzle of the cooling device 26 is placed between the first nip roller 18 and the second nip roller 20 to blow air on the back surface (the opposite surface of the transfer surface) of the resin material 14 that is being conveyed. Thus, the temperature of the resin material 14 can be controlled both by the rollers 16, 18 and 20 and the cooling device 26.

For a temperature and the amount of supply (the amount of blowing flow) of the air of the cooling device 26, optimum values need to be selected depending on the material of the resin material 14, the temperature at melting (for example, the slit outlet of the die 12) of the resin material 14, the conveying velocity of the resin material 14, the outer diameter of the mold roller 16, the shape of the asperity pattern of the mold roller 16, the set temperatures of the nip rollers (the first nip roller 18 and the second nip roller 20), or the like.

In order to monitor a surface temperature of each spot on the rollers 16, 18 and 20 and the resin material 14 described above, surface temperature measuring device (not shown) is preferably provided. As such surface temperature measuring device, various known measuring device may be used such as an infrared thermometer or a radiation thermometer.

As spots measured by the surface temperature measuring device, a plurality of points along the width of the resin material 14 between the die 12 and the first nip roller 18, a plurality of points along the width of the resin material 14 immediately after the second nip roller 20, surfaces (surfaces opposite from the rollers) of a plurality of points along the width of the resin material 14 wound around the mold roller 16 are considered.

Monitoring results of the surface temperature measuring device may be fed back to the temperature adjusting device of each of the rollers 16, 18 and 20 or the die 12 or the like to be reflected on the temperature control of each of the rollers 16, 18 and 20, or the like. An operation by feed forward control may be allowed without providing the surface temperature measuring device.

Tension detecting device for detecting tension of the resin material 14 or thickness detecting device (a thickness sensor) for detecting a thickness of the resin material 14 may be preferably provided in the production line 100 of the resin sheet in FIG. 5 or on a downstream side thereof. Detection results by the detecting device may be compared to set values and fed back to the draw control described above.

The slow cooling zone 30 (or the annealing zone) is provided to prevent sudden temperature changes of the resin material 14 after the peeling from the mold roller 16.

For example, when the resin is wound around the rollers and molded in a configuration having the mold roller 16, the first nip roller 18, and the second nip roller 20, internal residual stress of compression and tensile stress that occurs in the resin sheet is released (annealing) by heating part or whole of the surface to correct warpage.

Descriptions on defects in sudden temperature changes of the resin material 14 and the slow cooling zone 30 are the same as in the first embodiment, and will be omitted.

On a downstream side of the slow cooling zone 30 (or the annealing zone), an unshown cleaning device (a cleaning zone), a defect testing device (a testing zone), a laminating device, a side cutter, a cross cutter, and a stacking portion are provided in this order. These devices are the same as in the first embodiment, and descriptions thereof will be omitted.

Next, the method of producing a resin sheet using the production line 100 of the resin sheet in FIG. 5 will be described.

The resin material 14 applied to the present invention is the same as in the first embodiment.

The sheet-like resin material 14 extruded from the die 12 is nipped by the mold roller 16 and the two nip rollers (the first nip roller 18 and the second nip roller 20) placed to face the mold roller 16, and the shapes of the asperities on the surface of the mold roller 16 are transferred to the resin material 14. Then, the resin material 14 after the transfer is drawn tangentially of the mold roller 16 and the nip roller 20 and thus peeled off from the mold roller 16. Unlike the conventional techniques, the resin material 14 is not wound around the peeling roller when peeled off from the mold roller 16, and thus the shapes of the asperities transferred from the mold roller 16 to the resin material 14 are not deformed during the peeling.

The temperature of the resin material 14 at a peeling point from the mold roller 16 is preferably a softening point (Ta) or less of the resin material 14. This is because when the resin material 14 is peeled off from the mold roller 16 by tangentially drawing the resin material 14, the resin material 14 immediately after the peeling is not supported in the air unlike the resin material 14 supported by the peeling roller as in the conventional technique, and if the resin material 14 remains soft at the softening point (Ta) or more, the resin material 14 itself may droop to cause deformation of the transferred shapes of the asperities. The example of the two nip rollers is described, but one nip roller or three or more nip rollers may be allowed.

Next, the resin material 14 peeled off from the mold roller 16 is slowly cooled in the slow cooling zone 30 (or the annealing zone) while being conveyed in the tangentially drawing direction, that is, the upper right direction in FIG. 5. The resin material 14 is passed through the slow cooling zone 30 (or the annealing zone) and thus slowly cooled. Then, the resin material 14 with deformation being removed is cut into a predetermined length in a product taking portion downstream and housed as resin sheet products.

The resin material 14 is slowly cooled while being conveyed in the tangentially drawing direction, and thus the resin material 14 peeled off from the mold roller 16 is slowly cooled while maintaining flatness, and the transferred shape of the asperity pattern can be fixed while being maintained. Thus, even a resin material having large thickness distribution along the width in molding may obtain a desired sectional shape.

In producing the resin sheet, an extruding velocity of the resin material 14 from the die 12 may be 0.1 to 50 m/min, preferably 0.3 to 30 m/min. Thus, the circumferential velocity of the mold roller 16 is substantially matched with the extruding velocity.

On the other hand, the nip rollers (the first nip roller 18 and the second nip roller 20) are preferably driven by an operation method of so-called draw control such that velocities are gradually increased in the order of the nip rollers 18 and 20 to be faster than the circumferential velocity of the mold roller 16. A draw value between the nip rollers 18 and 20 is preferably 0 to 3%, more preferably 0 to 1%.

Uneven velocity of each of the rollers 16, 18 and 20 is preferably controlled to be within 1% of a set value.

Pressing pressure of each nip roller (the first nip roller 18 and the second nip roller 20) on the mold roller 16 is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

Temperature control of the nip rollers 18 and 20 is preferably set individually so that roller temperatures can be reduced in the order of the first nip roller 18 and the second nip roller 20. Then, the temperature of the resin material 14 at the peeling point from the mold roller 16 is preferably the softening point (Ta) or less of the resin as described above. For example, when polymethyl methacrylate resin is used as the resin material 14, the temperature of the resin material 14 at the peeling point is preferably 50 to 110° C.

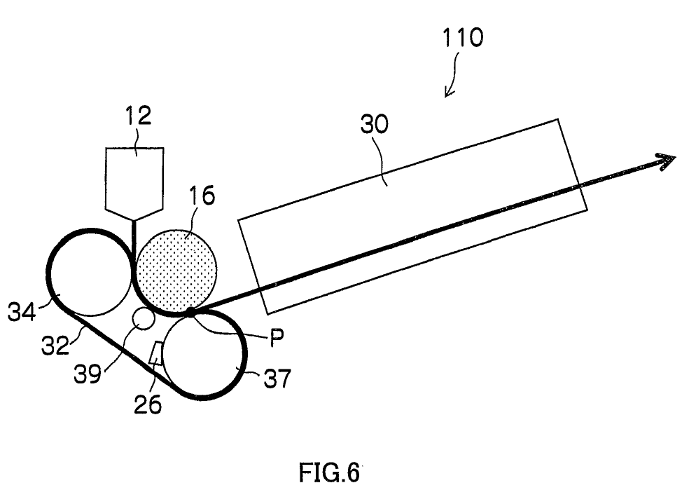

Next, a further embodiment (a fourth embodiment) of a method of producing a resin sheet according to the present invention will be described. FIG. 6 is a configuration view of a production line 110 of a resin sheet to which the method of producing a resin sheet according to the present invention is applied. The same or similar members as in the third embodiment in FIG. 5 will be denoted by the same reference numerals, and descriptions thereof will be omitted.

In the fourth embodiment, instead of the nip rollers (the first nip roller 18 and the second nip roller 20) in the third embodiment, a nip belt 32 and a plurality of press rollers 34, 37 and 39 are used.

In the production line 110 of the resin sheet, the first press roller 34 and the second press roller 37 are placed in positions corresponding to the first nip roller 18 and the second nip roller 20 in the production line 100 of the resin sheet (the third embodiment), and have substantially the same functions. An endless nip belt 32 is wound around the first press roller 34 and the second press roller 37, and the third press roller 39 placed to face a mold roller 16 via the nip belt 32 between the rollers 34 and 37. Thus, the resin material 14 is nipped by the nip belt 32 that is the endless belt and the mold roller 16, which increases a distance of the resin material 14 being nipped to facilitate obtaining a desired sectional shape.

Surface states (surface roughness, or the like) of the nip belt 32, a material of the nip belt 32, or the like are the same as in the second embodiment, and descriptions thereof will be omitted.

As described above, the press rollers 34, 37 and 39 have the same functions as the nip rollers in the third embodiment, and thus various configurations of the press rollers may be the same as those of the nip rollers in the third embodiment, such as a configuration with drive device, a configuration with pressurizing device, a configuration with temperature adjusting device, or a configuration that prevents bending caused by a reaction of pressure.

However, the press rollers 34, 37 and 39 do not come into direct contact with the resin material 14 after the molding, and thus finished states of surfaces of the press rollers 34, 37 and 39 may be poorer than those of the nip rollers in the third embodiment.

The nip belt 32 moves at a uniform velocity, which eliminates the need for a configuration corresponding to the operation method of so-called draw control in the third embodiment. If the nip belt 32 moves at a uniform velocity, not all the press rollers 34, 37 and 39 may have drive device.

The first press roller 34 and the second press roller 37 require a function of allowing conveyance of the nip belt 32 at a uniform velocity (drive device), and a function of providing predetermined tension to the nip belt 32 to prevent slips between the nip belt 32 and the press rollers 34, 37 and 39 (tension adjusting device). The tension adjusting device may have the same configuration as the pressurizing device provided in each nip roller in the third embodiment.

In the production line 110 of the resin sheet in FIG. 6, a cooling device 26 is provided as in the third embodiment and has a temperature adjusting function of the nip belt 32. The cooling device 26 may have the same configuration as the cooling devices 26 and 28 in the third embodiment. In FIG. 6, only one cooling device 26 is shown, but a plurality of cooling devices may be provided. Thus, the nip belt 32 itself is cooled to increase a distance of the resin material 14 cooled from a back surface thereof (a surface opposite from the surface in contact with the mold roller), thereby facilitating reducing the temperature of the resin material 14 at the peeling point P to the softening point (Ta) or less.

Next, the method of producing a resin sheet using the production line 110 of the resin sheet in FIG. 6 will be described.

The sheet-like resin material 14 extruded from the die 12 is nipped by the mold roller 16 and the nip belt 32 placed to face the mold roller 16, and shapes of asperities on the surface of the mold roller 16 are transferred to the resin material 14. Then, the resin material 14 after the transfer is drawn tangentially of the mold roller and the press roller 37 placed in the most downstream position among the plurality of press rollers 34, 37 and 39 and thus peeled off from the mold roller 16.

Next, the resin material 14 peeled off from the mold roller 16 is slowly cooled in a slow cooling zone 30 (or an annealing zone) while being conveyed in the tangentially drawing direction, that is, the upper right direction in FIG. 6. The resin material 14 is passed through the slow cooling zone 30 (or the annealing zone) and thus slowly cooled. Then, the resin material 14 with deformation being removed is cut into a predetermined length in a product taking portion downstream and housed as resin sheet products. Thus, even a resin sheet having large thickness distribution along the width in molding may obtain a desired sectional shape.

In producing the resin sheet, an extruding velocity of the resin material 14 from the die 12 may be 0.1 to 50 m/min, preferably 0.3 to 30 m/min. Thus, the circumferential velocities of the mold roller 16 and the nip belt 32 are substantially matched with the extruding velocity.

Pressing pressure of each press roller (the first press roller 34, the second press roller 37, and the third press roller 39) on the mold roller 16 is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm). The tension of the nip belt 32 by tension adjusting device (a guide roller 42 or 44) is more preferably 0.1 to 100 kN/m (0.1 to 100 kgf/cm).

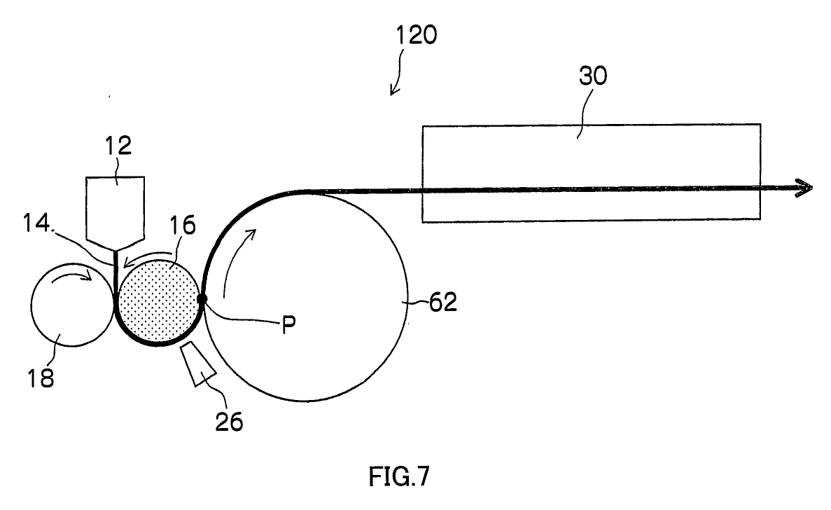

Next, a further embodiment (a fifth embodiment) of a method of producing a resin sheet according to the present invention will be described in detail. FIG. 7 is a configuration view of a production line 120 of a resin sheet to which the method of producing a resin sheet according to the present invention is applied. The same or similar members as in the third and fourth embodiments in FIGS. 5 and 6 will be denoted by the same reference numerals, and descriptions thereof will be omitted.

The production line 120 of the resin sheet in the fifth embodiment includes a die 12 for a sheet for molding a resin material 14 molten by an extruder (not shown) into a sheet, a mold roller 16 having shapes of asperities on a surface thereof, a first nip roller 18 placed to face the mold roller 16, a peeling roller 62, a cooling device 26, and a slow cooling zone 30 (or an annealing zone). In FIG. 7, one first nip roller 18 is shown, but a plurality of nip rollers may be provided.

The peeling roller 62 has a large diameter of 500 mm or more, preferably 1000 mm or more that is twice or more, preferably four times or more a diameter of the mold roller 16.

A material of the peeling roller 62, surface roughness of the peeling roller 62, rotatable driving of the peeling roller 62, or the like are the same as in the first embodiment, and descriptions thereof will be omitted.

The peeling roller 62 has temperature adjusting device. Such temperature adjusting device is provided to control to prevent a temperature increase of the peeling roller 62 caused by the hot resin material 14 or a sudden temperature decrease thereof.

As such temperature adjusting device, a configuration of circulating oil with an adjusted temperature in the roller is preferably used. Supply and discharge of the oil can be achieved by a configuration having a rotary joint at an end of the roller. As other temperature adjusting device, various known device may be used such as a configuration with a sheath heater incorporated into the peeling roller 62 or a configuration with dielectric heating device provided near the peeling roller 62.

Next, the method of producing a resin sheet using the production line 120 of the resin sheet in FIG. 7 will be described.

The sheet-like resin material 14 extruded from the die 12 is nipped by the mold roller 16 and the first nip roller 18 placed to face the mold roller 16, and shapes of asperities on the surface of the mold roller 16 are transferred to the resin material 14. Then, the resin material 14 after the transfer is wound around the peeling roller 62 placed to face the mold roller 16 and having the large diameter of 500 mm or more that is twice or more the diameter of the mold roller and thus peeled off from the mold roller 16.

The use of the peeling roller 62 having the large diameter allows the resin material 14 to be drawn substantially tangentially of the mold roller 16 as in the third and the fourth embodiments. Thus, the shapes of the asperities transferred to the resin material 14 are not deformed during the peeling even in use of the peeling roller 62.

Specifically, in the fifth embodiment, the resin material 14 is wound around the peeling roller 62 having a large radius of curvature to prevent deformation of the transferred shapes of the asperities. In the fifth embodiment, the peeled resin material 14 is supported by the peeling roller 62, and also cooled by the peeling roller 62 to cool and harden the shapes of the asperities, which eliminates the need for extremely high accuracy of control for reducing the temperature of the resin material 14 at the peeling point P to the softening point or less.

Next, the resin material 14 peeled off from the peeling roller 62 is conveyed in the horizontal direction, and slowly cooled in the slow cooling zone 30 (or the annealing zone). The resin material 14 is passed through the slow cooling zone 30 (or the annealing zone) and thus slowly cooled. Then, the resin material 14 with deformation being removed is cut into a predetermined length in a product taking portion downstream and housed as resin sheet products. Thus, even a resin sheet having large thickness distribution along the width in molding may obtain a desired sectional shape.

In producing the resin sheet, an extruding velocity of the resin material 14 from the die 12 may be 0.1 to 50 m/min, preferably 0.3 to 30 m/min. Thus, the circumferential velocity of the mold roller 16 is substantially matched with the extruding velocity.

Pressing pressure of the first nip roller 18 on the mold roller 16 is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

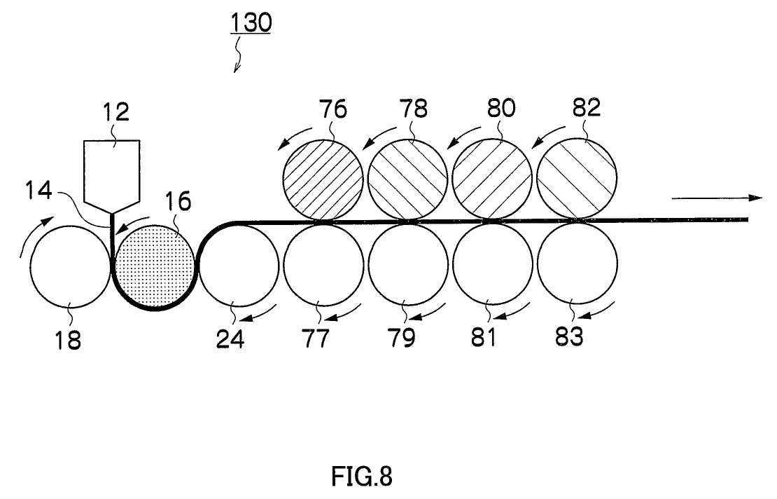

Next, a further embodiment (a sixth embodiment) of a method of producing a resin sheet according to the present invention will be described in detail with reference to the accompanying drawings. FIG. 8 is a configuration view of a production line of a resin sheet to which the method of producing a resin sheet according to the present invention is applied.

A production line 130 of the resin sheet includes a die 12 for a sheet for molding a resin material 14 molten by an extruder (not shown) into a sheet, a first mold roller 16 having shapes of asperities on a surface thereof, a first nip roller 18 placed to face the first mold roller 16, a peeling roller 24 placed to face the first mold roller 16, a second mold roller 76 placed on an upper side of the resin material 14 downstream of the peeling roller 24, a second nip roller 77 placed to face the second mold roller 76 via the resin material 14 (placed on a lower side of the resin material 14), a third mold roller 78 placed on the upper side of the resin material 14 further downstream, a third nip roller 79 placed to face the third mold roller 78 via the resin material 14 (placed on the lower side of the resin material 14), a fourth mold roller 80 placed on the upper side of the resin material 14 further downstream, a fourth nip roller 81 placed to face the fourth mold roller 80 via the resin material 14 (placed on the lower side of the resin material 14), a fifth mold roller 82 placed on the upper side of the resin material 14 further downstream, and a fifth nip roller 83 placed to face the fifth mold roller 82 via the resin material 14 (placed on the lower side of the resin material 14).

A slit size of the die 12 is formed so that a width of the molded molten resin material 14 is larger than a width of the first mold roller 16, and the die 12 is placed so that the resin material 14 extruded from the die 12 is extruded out between the first mold roller 16 and the first nip roller 18.

Each of the mold rollers (the first mold roller 16 to the fifth mold roller 82) has regular shapes of asperities on a surface thereof. The regular shapes of the asperities may be, for example, inverted shapes of the resin material 14 after the molding as shown in FIG. 2.

Specifically, a back surface of the resin material 14 is flat, and a linear asperity pattern parallel to the arrow is formed on a surface of the resin material 14. The arrow shows a traveling (conveying) direction of the resin material 14. Thus, endless grooves of the inverted shapes on an end surface 14A may be formed on the surface of the mold roller 16. Details on a shape of the asperity pattern on the surface of the resin material 14 are as described above.

However, even with such endless grooves formed in the first mold roller 16 that is the mold roller in the most upstream position, it is often hard for the resin material 14 to follow the shape, and the resin material 14 may be formed into a design shape by downstream mold rollers. Thus, the plurality of sets of mold rollers may be provided to gradually bring the shapes of the asperities transferred to the resin material 14 close to design shapes.

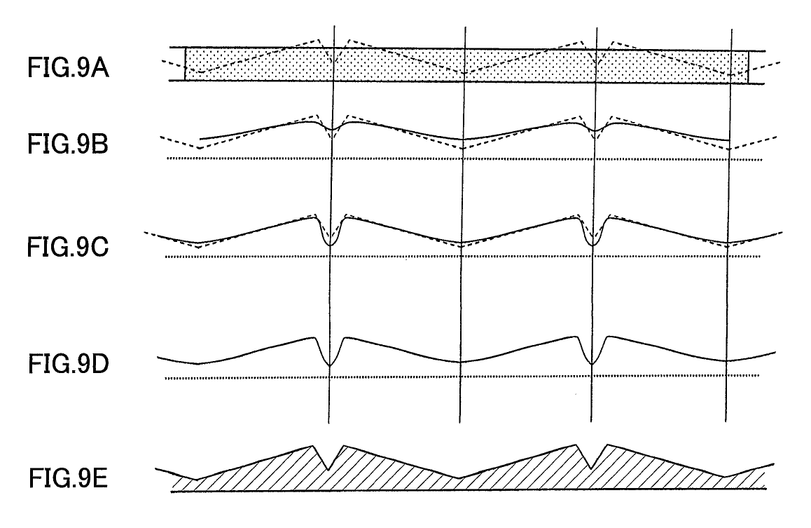

FIGS. 9A to 9E are sectional views of the resin material 14 in respective molding steps. FIG. 9A shows a section of the resin material 14 immediately after the die 12, and FIG. 9E shows a section of a design shape of a product. FIGS. 9B, 9C and 9D midway show sections of a process of the resin material 14 being gradually brought close to the design shape.

Thus, endless grooves of inverted shapes of such shapes may be formed on the surface of each mold roller. Imaginary lines (dash-double-dot lines) in FIGS. 9A to 9D show sections of the design shape of the product.

A material of each mold roller, a forming method of the asperity pattern on the surface of each mold roller, surface roughness of each mold roller, rotatable driving of each mold roller, temperature adjusting device of each mold roller, or the like are the same as in the first embodiment, and descriptions thereof will be omitted.

The nip rollers (the first nip roller 18 to the fifth nip roller 83) are rollers that are placed to face the mold rollers (the first mold roller 16 to the fifth mold roller 82) and nip the resin material 14 in cooperation with the mold rollers.

The peeling roller 24 is a roller that is placed to face the first mold roller 16, nips the resin material 14 in cooperation with the first mold roller 16, and peels the resin material 14 off from the first mold roller 16 by the resin material 14 being wound around the peeling roller 24, and is placed on a downstream side 180° away from the first nip roller 18 via the first mold roller 16.

The surfaces of the nip rollers and the peeling roller 24 are preferably mirror finished. Such surfaces allow a satisfactory state of the back surface of the resin material 14 after the molding. Surface roughness (Ra) of the nip rollers and the peeling roller 24 is preferably 0.5 μm or less, more preferably 0.2 μm or less.

As materials of the nip rollers and the peeling roller 24, various steel members, stainless steel, copper, zinc, brass, these metal materials used as core bars with surfaces lined with rubber, these metal materials plated with Hcr, Cu or Ni, ceramics, and various composite materials may be used.

The nip rollers and the peeling roller 24 are rotatably driven by unshown drive device at a predetermined circumferential velocity in the direction of arrow in FIG. 8. A configuration such that no drive device is provided in each nip roller may be allowed, but providing the drive device is preferable for obtaining a satisfactory state of the back surface of the resin material 14.

When the drive device is provided in each mold roller and each nip roller, a configuration having varying drive velocities is preferably used. Thus, an operation method may be used of gradually increasing the velocities (at most within a few percent) in the order of the second mold roller 76 and the second nip roller 77, the third mold roller 78 and the third nip roller 79, the fourth mold roller 80 and the fourth nip roller 81, and the fifth mold roller 82 and the fifth nip roller 83 to be faster than the circumferential velocity of the first mold roller 16.

The nip rollers and the peeling roller 24 each have unshown pressurizing device so as to be able to nip the resin material 14 between the mold rollers and the nip rollers and the peeling roller 24 with predetermined pressure. The pressurizing device has a configuration of applying pressure in the direction of the normal to contact points between the mold rollers and the nip rollers and the peeling roller 24, and various known device such as motor drive device, an air cylinder, or a hydraulic cylinder may be used.

A configuration that prevents bending caused by a reaction of a pressurizing force provided in each nip roller and the peeling roller 24 may be the same as in each nip roller in the first embodiment.

The nip rollers and the peeling roller 24 each have temperature adjusting device. The temperature adjusting device is individually controlled so that roller temperatures can be reduced in the order of the peeling roller 24, the second mold roller 76 and the second nip roller 77, the third mold roller 78 and the third nip roller 79, the fourth mold roller 80 and the fourth nip roller 81, and the fifth mold roller 82 and the fifth nip roller 83. This allows a satisfactory shape of the asperity pattern on the surface of the resin material 14.

Too low a set temperature of the first nip roller 18 causes sudden cooling of the molten resin material 14, thereby unpreferably causing deformation in the resin material 14. Too high a set temperature of the fifth nip roller 83 causes the resin material 14 to be peeled off from the fifth mold roller 82, which unpreferably causes deformation of the shape of the asperity pattern after the surface of the resin material 14 becomes free.

Too low a set temperature of the peeling roller 24 increases viscosity of the resin material 14, thereby unpreferably preventing the resin material 14 from being wound around the peeling roller 24.

For set temperatures of the mold rollers, the peeling roller 24, and the nip rollers, optimum values need to be selected depending on a material of the resin material 14, a temperature at melting (for example, a slit outlet of the die 12) of the resin material 14, a conveying velocity of the resin material 14, an outer diameter of the first mold roller 16, the shape of the asperity pattern of the first mold roller 16, or the like.

In order to monitor a surface temperature of each spot on the rollers and the resin material 14, surface temperature measuring device (not shown) is preferably provided. As such surface temperature measuring device, various known measuring device may be used such as an infrared thermometer or a radiation thermometer.

As spots measured by the surface temperature measuring device, a plurality of points along the width of the resin material 14 between the die 12 and the first nip roller 18, a plurality of points along the width of the resin material 14 immediately after the peeling roller 24, surfaces (surfaces opposite from the rollers) of a plurality of points along the width of the resin material 14 wound around the first mold roller 16 or the peeling roller 24 are considered.

Monitoring results of the surface temperature measuring device may be fed back to the temperature adjusting device of each roller or the die 12 or the like to be reflected on the temperature control of each roller. An operation by feed forward control may be allowed without providing the surface temperature measuring device.

Tension detecting device for detecting tension of the resin material 14 or thickness detecting device (a thickness sensor) for detecting a thickness of the resin material 14 may be preferably provided in the production line 130 of the resin sheet in FIG. 8 or on a downstream side thereof. Detection results by the detecting device may be compared to set values and fed back to draw control described later.

In the production line 130 of the resin sheet in FIG. 8, a cooling device may be provided. For example, an air nozzle is provided to blow air with a controlled temperature and a controlled amount of blow to each nip roller and assist temperature control of each nip roller, or an air nozzle is provided to blow air with a controlled temperature and a controlled amount of blow to the back surface of the resin material 14 from between the nip rollers and assist temperature control of the resin material 14.

In providing such a cooling device, for a temperature and the amount of supply (the amount of blowing flow) of the air of the cooling device, optimum values need to be selected depending on the material of the resin material 14, the temperature at melting (for example, the slit outlet of the die 12) of the resin material 14, the conveying velocity of the resin material 14, the outer diameter of the first mold roller 16, the shape of the asperity pattern of the first mold roller 16, the set temperatures of the nip rollers, or the like.

A slow cooling zone (or an annealing zone (a correcting zone of warpage caused by single sided heating)) may be provided on a downstream side of the production line 130. Such a slow cooling zone is provided to prevent sudden temperature changes in the resin material 14 on the downstream side of the production line 130 of the resin sheet.

For example, when the resin is wound around the rollers and molded in a configuration having the first mold roller 16, the first nip roller 18, and the peeling roller 24, internal residual stress of compression and tensile stress that occur in the resin material 14 is released (annealing) by heating part or whole of the surface to correct warpage.

When a sudden temperature change occur in the resin material 14, for example, the resin material 14 is plastic near the surface but elastic inside, and shrinkage caused by curing of the inside degrades the shape of the surface of the resin material 14. A temperature difference occurs between the front and back surfaces of the resin material 14 to cause warpage in the resin material 14.

The slow cooling zone (or the annealing zone), a cleaning device (a cleaning zone) provided downstream of the production line 130 of the resin sheet (downstream of the slow cooling zone) in FIG. 8, a defect testing device (a testing zone), a laminating device, a side cutter, a cross cutter, and a stacking portion are the same as in the first embodiment, and descriptions thereof will be omitted.

Next, the method of producing a resin sheet using the production line 130 of the resin sheet in FIG. 8 will be described.

The resin material 14 applied to the present invention may be thermoplastic resin as in the first embodiment. Detailed descriptions thereof will be omitted.

The sheet-like resin material 14 extruded from the die 12 is nipped by the first mold roller 16 and the first nip roller 18 placed to face the first mold roller 16, the shapes of the asperities on the surface of the first mold roller 16 are transferred to the resin material 14, and the resin material 14 is wound around the peeling roller 24 placed to face the first mold roller 16 and thus peeled off from the first mold roller 16. Before the peeling, the resin material 14 is also nipped by the first mold roller 16 and the peeling roller 24, and the shapes of the asperities on the surface of the first mold roller 16 are transferred to the resin material 14.

The resin material 14 peeled off from the first mold roller 16 is conveyed in the horizontal direction, then nipped by the second mold roller 76 and the second nip roller 77 placed to face the second mold roller 76, and the shapes of the asperities on the surface of the second mold roller 76 are transferred to the resin material 14. The resin material 14 is then nipped by the third mold roller 78 and the third nip roller 79 placed to face the third mold roller 78, and the shapes of the asperities on the surface of the third mold roller 78 are transferred to the resin material 14. The resin material 14 is then nipped by the fourth mold roller 80 and the fourth nip roller 81 placed to face the fourth mold roller 80, and the shapes of the asperities on the surface of the fourth mold roller 80 are transferred to the resin material 14. The resin material 14 is then nipped by the fifth mold roller 82 and the fifth nip roller 83 placed to face the fifth mold roller 82, and the shapes of the asperities on the surface of the fifth mold roller 82 are transferred to the resin material 14.

Then, the resin material 14 is passed through the slow cooling zone (or the annealing zone) and thus slowly cooled as required, and the resin material 14 with deformation being removed is cut into a predetermined length in a product taking portion downstream and housed as resin sheet products.

In producing the resin sheet, an extruding velocity of the resin material 14 from the die 12 may be 0.1 to 50 m/min, preferably 0.3 to 30 m/min. Thus, the circumferential velocity of the first mold roller 16 is substantially matched with the extruding velocity.

On the other hand, the successive mold rollers (the second mold roller 76, the third mold roller 78, the fourth mold roller 80, and the fifth mold roller 82) and the nip rollers (the second nip roller 77, the third nip roller 79, the fourth nip roller 81, and the fifth nip roller 83) are driven by an operation method of so-called draw control such that velocities are gradually increased in the order of the second, third, fourth, and fifth rollers to be faster than the circumferential velocity of the first mold roller 16. A draw value between each of the mold rollers and each of the nip rollers is preferably 0 to 3%, more preferably 0 to 1%.

Uneven velocity of each roller is preferably controlled to be within 1% of a set value.

Pressing pressure of each of the nip rollers (the first nip roller 18 to the fifth nip roller 83) and the peeling roller 24 on each of the mold rollers (the first mold roller 16 to the fifth mold roller 82) is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

In order to obtain a predetermined thickness of the product of the resin material 14, besides proper control of the pressing pressure of each nip roller, proper control of a clearance between each of the nip rollers (the first nip roller 18 to the fifth nip roller 83) and the peeling roller 24 and each of the mold rollers (the first mold roller 16 to the fifth mold roller 82) may be preferably used.

Temperature control of the nip rollers (the first nip roller 18 to the fifth nip roller 83) and the peeling roller 24 is preferably set individually so that roller temperatures can be reduced in the order of the peeling roller 24, the second nip roller 77, the third nip roller 79, the fourth nip roller 81, and the fifth nip roller 83.

Then, the temperature of the resin material 14 at the fifth nip roller 83 is preferably the softening point (Ta) or less of the resin. When polymethyl methacrylate resin is used as the resin material 14, a set temperature of the fifth nip roller 83 may be 50 to 110° C.

Next, a further embodiment (a seventh embodiment) of a method of producing a resin sheet according to the present invention will be described. FIG. 10 is a configuration view of a production line 140 of a resin sheet to which the method of producing a resin sheet according to the present invention is applied. The same or similar members as in the sixth embodiment in FIG. 8 will be denoted by the same reference numerals, and descriptions thereof will be omitted.

In the embodiment, instead of the nip rollers (the first nip roller 18 and the fifth nip roller 83) and the peeling roller 24 in the sixth embodiment, back mold rollers (a first back mold roller 35 to a fifth back mold roller 93) and a peeling roller 24′ are used. Front mold rollers (a first front mold roller 16 to a fifth front mold roller 82) are the same as in the sixth embodiment, and correspond to the first mold roller 16 to the fifth mold roller 82 in the sixth embodiment.

In the production line 140 of the resin sheet, a shape of an asperity pattern is formed on a surface of a resin sheet 14 by the front mold rollers (the first front mold roller 16 to the fifth front mold roller 82) as in the sixth embodiment. The difference from the sixth embodiment is that the shape of the asperity pattern is also formed on the back surface of the resin sheet 14.

As described above, the back mold rollers (the first back mold roller 35 to the fifth back mold roller 93) and the peeling roller 24′ have the same functions as the nip rollers and the peeling roller 24 in the sixth embodiment, and thus various configurations of the rollers may be the same as those of the nip rollers in the sixth embodiment, such as a finished state of a surface, a configuration with drive device, a configuration with pressurizing device, a configuration with temperature adjusting device, or a configuration that prevents bending caused by a reaction of pressure.

However, the shape of the asperity pattern is formed on the surfaces of the back mold rollers (the first back mold roller 35 to the fifth back mold roller 93) and the peeling roller 24′, and thus in the configuration that prevents bending caused by a reaction of pressure, it is difficult to use a configuration with a backup roller provided on a back surface side of the roller (a side opposite from each mold roller), and a configuration using a crowned shape.

In the production line 140 of the resin sheet in FIG. 10, a cooling device or a slow cooling zone (or an annealing zone) may be provided as required as in the sixth embodiment, and configurations thereof may be the same as in the sixth embodiment.

Next, the method of producing a resin sheet using the production line 140 of the resin sheet in FIG. 10 will be described.

The sheet-like resin material 14 extruded from the die 12 is nipped by the first mold roller 16 and the first back mold roller 35 placed to face the first mold roller 16, the shapes of the asperities on the surfaces of the first mold roller 16 and the first back mold roller 35 are transferred to the resin material 14, and the resin material 14 is wound around the peeling roller 24′ and thus peeled off from the first mold roller 16.

The resin material 14 peeled off from the first mold roller 16 is conveyed in the horizontal direction, then successively nipped by the mold rollers (the second mold roller 76 to the fifth mold roller 82) and the back mold rollers (the second back mold roller 87 to the fifth back mold roller 93), and the shapes of the asperities on the surfaces of the mold rollers (the second mold roller 76 to the fifth mold roller 82) and the back mold rollers (the second back mold roller 87 to the fifth back mold roller 93) are transferred to the front and back surfaces of the resin material 14. Then, the resin material 14 is passed through the slow cooling zone (or the annealing zone) and thus slowly cooled as required, and the resin material 14 with deformation being removed is cut into a predetermined length in a product taking portion downstream and housed as resin sheet products.

In producing the resin sheet, an extruding velocity of the resin material 14 from the die 12 may be 0.1 to 50 m/min, preferably 0.3 to 30 m/min. Thus, the circumferential velocities of the first mold roller 16 and the first back mold roller 35 are substantially matched with the extruding velocity.

Pressing pressure of each of the back mold rollers (the first back mold roller 35 to the fifth back mold roller 93) and the peeling roller 24′ on each of the mold rollers (the first mold roller 16 to the fifth mold roller 82) is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

In order to obtain a predetermined thickness of the product of the resin material 14, besides proper control of the pressing pressure of each of the back mold rollers (the first back mold roller 35 to the fifth back mold roller 93) and the peeling roller 24′, proper control of a clearance between each of the back mold rollers (the first back mold roller 35 to the fifth back mold roller 93) and the peeling roller 24′ and each of the mold rollers (the first mold roller 16 to the fifth mold roller 82) may be preferably used.

Temperature control of the back mold rollers (the first back mold roller 35 to the fifth back mold roller 93) and the peeling roller 24′ is preferably controlled individually so that roller temperatures can be reduced in the order of the peeling roller 24′, the second back mold roller 87, the third back mold roller 89, the fourth back mold roller 91, and the fifth back mold roller 93.

Then, the temperature of the resin material 14 at the fifth back mold roller 93 is preferably the softening point Ta or less of the resin. When polymethyl methacrylate resin is used as the resin material 14, a set temperature of the fifth back mold roller 93 may be 50 to 110° C.

According to the seventh embodiment using the production line 140 of the resin sheet, the predetermined asperity pattern may be formed on the front and back surfaces of the resin material 14. Asperity patterns on the back surface include a fine pattern disclosed in Japanese Patent Application Laid-Open No. 7-314567, a prism shape (with 10 to 200 μm pitch and a vertical angle of 45 to 100°), a lenticular lens, a Fresnel lens, grain embossing (a light diffusion pattern), or the like.

The production line 140 may be preferably applied when the resin material 14 after the molding is used as a light guide plate.

For example, in roller molding of PMMA after extrusion, if thickness distribution is provided along the width, and a difference in thickness between the thickest portion and the thinnest portion is large as shown in FIGS. 2 and 3, so-called shrinkage cavities are often caused in the back surface by shrinkage during curing of the resin depending on a machining condition.

Specifically, in the thick portion of the resin material 14, a difference occurs in a cooling velocity between the surface and the inside of the resin material 14, and the resin material 14 is elastic near the surface but plastic inside. Then, shrinkage of the inside that cures after a delay causes a recess in a corresponding surface portion of the resin material 14.

For example, when the lenticular lens is molded, a shallow recessed groove corresponding to a curved surface is often provided in the back surface.

On the other hand, the inverted shapes of the asperities are formed on the surfaces of the back mold rollers (the first back mold roller 35 to the fifth back mold roller 93) and the peeling roller 24′ so that the back surface of the resin material 14 becomes flat with the shrinkage cavities. The use of this method allows the advantage of the embodiment to be provided for the lenticular lens or the resin material 14 having the design shape such that the back surface becomes flat as in FIGS. 2 and 3.

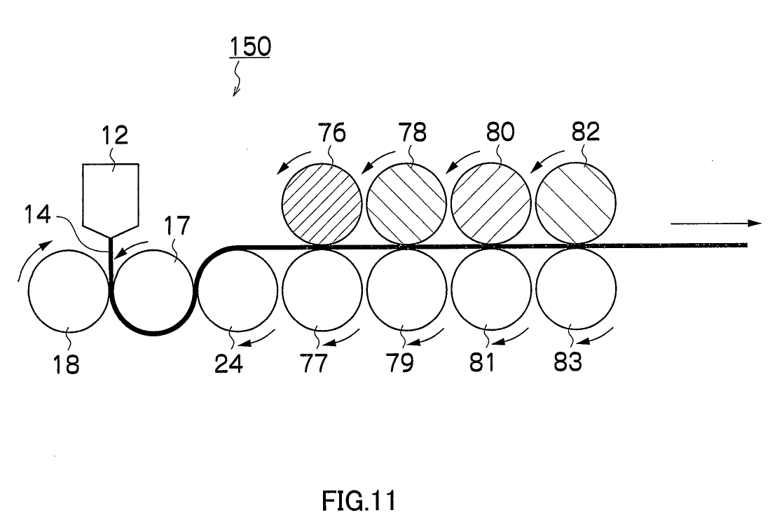

Next, a further embodiment (an eighth embodiment) of a method of producing a resin sheet according to the present invention will be described in. FIG. 11 is a configuration view of a production line 150 of a resin sheet to which the method of producing a resin sheet according to the present invention is applied. The same or similar members as in the sixth embodiment in FIG. 8 will be denoted by the same reference numerals, and descriptions thereof will be omitted.

In the embodiment, instead of the first mold roller 16 in the sixth embodiment, a mirror finished roller 17 is used. Other configurations are the same as in the sixth embodiment, and names of rollers only are different. Specifically, the mirror finished roller 17 (corresponding to a first mirror finished roller in the claims), a first mold roller 76, a second mold roller 78, a third mold roller 80, and a fourth mold roller 82 only have names different from those in the sixth embodiment. The first nip roller 18 corresponds to a second mirror finished roller in the claims.

In the production line 150 of the resin sheet, a shape of an asperity pattern is formed on a surface of a resin sheet 14 by the mold rollers (the first mold roller 76 to the fourth mold roller 82) as in the sixth embodiment. The difference from the sixth embodiment is that no shape of the asperity pattern is formed on the surface of the resin sheet 14 and the resin sheet 14 is flat until the resin material 14 passes through the peeling roller 24.

The difference of the mirror finished roller 17 from the first mold roller 16 in the sixth embodiment is only that no shape of the asperity pattern is formed on the surface, and thus descriptions on the configuration of the mirror finished roller 17 will be omitted. The surface of the mirror finished roller 17 may be the same as that of the first nip roller 18 in the sixth embodiment, and surface roughness (Ra) of the mirror finished roller 17 is preferably 0.5 μm or less, more preferably 0.2 μm or less.

Next, the method of producing a resin sheet using the production line 150 of the resin sheet in FIG. 11 will be described.

The sheet-like resin material 14 extruded from the die 12 is nipped by the mirror finished roller 17 and the first nip roller 18 placed to face the mirror finished roller 17 to mold the resin material 14 into a flat sheet having a predetermined thickness, and the resin material 14 is wound around the peeling roller 24 placed to face the mirror finished roller 17 and thus peeled off from the mirror finished roller 17. Before the peeling, the resin material 14 is also nipped by the mirror finished roller 17 and the peeling roller 24 to roll the resin material 14 into a predetermined thickness.

The resin material 14 peeled off from the mirror finished roller 17 is conveyed in the horizontal direction, then nipped by the first mold roller 76 and the second nip roller 77 placed to face the first mold roller 76, and the shapes of the asperities on the surface of the first mold roller 76 are transferred to the resin material 14. The resin material 14 is then nipped by the second mold roller 78 and the third nip roller 79 placed to face the second mold roller 78, and the shapes of the asperities on the surface of the second mold roller 78 are transferred to the resin material 14. The resin material 14 is then nipped by the third mold roller 80 and the fourth nip roller 81 placed to face the third mold roller 80, and the shapes of the asperities on the surface of the third mold roller 80 are transferred to the resin material 14. The resin material 14 is then nipped by the fourth mold roller 82 and the fifth nip roller 83 placed to face the fourth mold roller 82, and the shapes of the asperities on the surface of the fourth mold roller 82 are transferred to the resin material 14.

Then, the resin material 14 is passed through the slow cooling zone (or the annealing zone) and thus slowly cooled as required, and the resin material 14 with deformation being removed is cut into a predetermined length in a product taking portion downstream and housed as resin sheet products.

In producing the resin sheet, an extruding velocity of the resin material 14 from the die 12 may be 0.1 to 50 m/min, preferably 0.3 to 30 m/min. Thus, the circumferential velocity of the mirror finished roller 17 is substantially matched with the extruding velocity.

On the other hand, the successive mold rollers (the first mold roller 76, the second mold roller 78, the third mold 80, and the fourth mold roller 82) and the nip rollers (the second nip roller 77, the third nip roller 79, the fourth nip roller 81, and the fifth nip roller 83) are driven by an operation method of so-called draw control such that velocities are gradually increased in the order of the first, second, third, and fourth rollers to be faster than the circumferential velocity of the mirror finished roller 17. A draw value between each of the mold rollers and each of the nip rollers is preferably 0 to 3%, more preferably 0 to 1%.

Pressing pressure of each of the nip rollers (the first nip roller 18 to the fifth nip roller 83) and the peeling roller 24 on the mirror finished roller 17 and each of the mold rollers (the first mold roller 76 to the fourth mold roller 82) is preferably equivalent to linear pressure (a value converted assuming that surface contact of each nip roller by elastic deformation is line contact) of 0 to 200 kN/m (0 to 200 kgf/cm), more preferably 0 to 100 kN/m (0 to 100 kgf/cm).

In order to obtain a predetermined thickness of the product of the resin material 14, besides proper control of the pressing pressure of each nip roller, proper control of a clearance between each of the nip rollers (the first nip roller 18 to the fifth nip roller 83) and the peeling roller 24 and the mirror finished roller 17 and each of the mold rollers (the first mold roller 76 to the fourth mold roller 82) may be preferably used.

Temperature control of the nip rollers (the first nip roller 18 to the fifth nip roller 83) and the peeling roller 24 is preferably controlled individually so that roller temperatures can be reduced in the order of the peeling roller 24, the second mold roller 76 and the second nip roller 77, the third nip roller 79, the fourth nip roller 81, and the fifth nip roller 83.

Then, the temperature of the resin material 14 at the fifth nip roller 83 is preferably the softening point (Ta) or less of the resin. When polymethyl methacrylate resin is used as the resin material 14, a set temperature of the fifth nip roller 83 may be preferably 50 to 110° C.

According to the method of producing a resin sheet of the present invention as described above, even a resin sheet having large thickness distribution along the width in molding may obtain a desired sectional shape.

The embodiments of the method of producing a resin sheet according to the present invention have been described, but the present invention is not limited to the embodiments, and various aspects may be adopted.

For example, for the number and arrangement of the nip rollers or the press rollers, various aspects other than the embodiments may be adopted as long as they have the same functions.

For the temperature adjusting device, the cooling device (26 or the like), and the slow cooling zone 30, various aspects other than the embodiments may be adopted as long as they have the same functions.

1. A method of producing a resin sheet, comprising the steps of:
nipping a sheet-like resin material extruded from a die by a mold roller and a plurality of nip rollers placed to face said mold roller;
transferring shapes of asperities on a surface of said mold roller said resin material; and
peeling said resin material after the transfer off from said mold roller by winding said resin material around a peeling roller placed to face said mold roller.

2. The method of producing a resin sheet according to claim 1, wherein a difference in thickness between the thickest portion and the thinnest portion along the width of said resin material is 1 mm or more with the shapes of the asperities transferred to said resin material.

3. The method of producing a resin sheet according to claim 1, wherein the thickness of the thinnest portion of said resin material is 5 mm or less.

4. The method of producing a resin sheet according to claim 1, further comprising the steps of:
providing a belt-like member between said mold roller and said plurality of nip rollers and/or said peeling roller; and
nipping said resin material by said belt-like member and said mold roller.

5. A method of producing a resin sheet, comprising the steps of:
nipping a sheet-like resin material extruded from a die by a mold roller and at least one nip roller placed to face said mold roller,
transferring shapes of asperities on a surface of said mold roller to said resin material; and
peeling said resin material after the transfer off from said mold roller by drawing said resin material in tangential direction of said mold roller and said nip roller.

6. A method of producing a resin sheet, comprising the steps of:
nipping a sheet-like resin material extruded from a die by a mold roller and a belt-like member provided between said mold roller and a plurality of press rollers placed to face said mold roller;
transferring shapes of asperities on a surface of said mold roller to said resin material; and
peeling said resin material after the transfer off from said mold roller by drawing said resin material in tangential direction of said mold roller and a press roller placed in the most downstream position among said plurality of press rollers.

7. The method of producing a resin sheet according to claim 5, wherein a temperature of said resin material at a peeling point from said mold roller is a softening point (Ta) or less of said resin material.

8. The method of producing a resin sheet according to claim 5, further comprising the step of:
slowly cooling said resin material in a slow cooling zone while conveying said resin material in said tangential direction of the drawing.

9. A method of producing a resin sheet, comprising the steps of:
nipping a sheet-like resin material extruded from a die by a mold roller and at least one nip roller placed to face said mold roller;
transferring shapes of asperities on a surface of said mold roller to said resin material; and
peeling said resin material after the transfer off from said mold roller by winding said resin material around a peeling roller placed to face said mold roller and having a large diameter of 500 mm or more that is twice or more a diameter of said mold roller.

10. The method of producing a resin sheet according to claim 5, wherein a difference in thickness between the thickest portion and the thinnest portion along the width of the resin material is 1 mm or more with the shapes of the asperities transferred to said resin material.

11. The method of producing a resin sheet according to claim 5, wherein the thickness of the thinnest portion of said resin material is 5 mm or less.

12. A method of producing a resin sheet, comprising the steps of:
nipping a sheet-like resin material extruded from a die by a first mold roller and a first nip roller placed to face said first mold roller;
transferring shapes of asperities on a surface of said first mold roller to said resin material;
peeling said resin material after the transfer off from said first mold roller by winding said resin material around a peeling roller placed to face said first mold roller;
nipping said resin material after the peeling by a second mold roller and a second nip roller placed to face said second mold roller; and
transferring shapes of asperities on a surface of said second mold roller to said resin material.

13. The method producing of a resin sheet according to claim 18 wherein lapping angles of said resin material wound around said second mold roller and said second nip roller are both less than 5 degrees.

14. The method of producing a resin sheet according to claim 12 further comprising the steps of:
providing at least one set of a mold roller and a nip roller having the same configurations as said second mold roller and said second nip roller on a downstream side in a traveling direction of said resin material of said second mold roller and said second nip roller; and
gradually bringing the shapes of the asperities transferred to said resin material close to design shapes.

15. A method of producing a resin sheet, comprising the steps of:
nipping a sheet-like resin material extruded from a die by a first front mold roller and a first back mold roller placed to face said first front mold roller;
transferring shapes of asperities on a surface of said first front mold roller and shapes of asperities on a surface of said first back mold roller to said resin material;
peeling said resin material after the transfer off from said first front mold roller by winding said resin material around a peeling roller placed to face said first front mold roller;
nipping said resin material after the peeling by a second front mold roller and a second back mold roller placed to face said second front mold roller; and
transferring shapes of asperities on a surface of said second front mold roller and shapes of asperities on a surface of said second back mold roller to said resin material.

16. The method of producing a resin sheet according to claim 15, wherein lapping angles of said resin material wound around said second front mold roller and said second back mold roller are both less than 5 degrees.

17. The method of producing a resin sheet according to claim 15, wherein at least one set of a front mold roller and a back mold roller having the same configurations as said second front mold roller and said second back mold roller are provided on a downstream side in a traveling direction of said resin material of said second front mold roller and said second back mold roller to gradually bring the shapes of the asperities transferred to said resin material close to design shapes.

18. The method of producing a resin sheet according to claim 15, wherein the shapes of the asperities substantially the same as the shapes of the asperities on the surface of said first back mold roller are formed on a surface of said peeling roller.

19. A method of producing a resin sheet, comprising the steps of:
nipping a sheet-like resin material extruded from a die by a first mirror finished roller and a second mirror finished roller placed to face said first mirror finished roller;
molding said resin material to have a predetermined thickness;
peeling said resin material after the molding off from said first mirror finished roller by winding said resin material around a peeling roller placed to face said first mirror finished roller;
nipping said resin material after the peeling by a mold roller and a nip roller placed to face said mold roller; and
transferring shapes of asperities on a surface of said mold roller to said resin material.

20. The method of producing a resin sheet according to claim 19, wherein lapping angles of said resin material wound around said mold roller and said nip roller are both less than 5 degrees.

21. The method of producing a resin sheet according to claim 19, further comprising the steps of:
providing a plurality of sets of said mold rollers and said nip rollers; and
gradually bringing the shapes of the asperities transferred to said resin material close to design shapes.

22. The method of producing a resin sheet according to claim 12, wherein a difference in thickness between the thickest portion and the thinnest portion along the width of said resin material is 1 mm or more with the shapes of the asperities transferred to said resin material.

23. The method of producing a resin sheet according to claim 12, wherein the thickness of the thinnest portion of said resin material is 5 mm or less.

24. The method of producing a resin sheet according to claim 6, wherein a
temperature of said resin material at a peeling point from said mold roller is a softening point (Ta) or less of said resin material.

25. The method of producing a resin sheet according to claim 6, further comprising the step of:
slowly cooling said resin material in a slow cooling zone while conveying said resin material in said tangential direction of the drawing.

26. The method of producing a resin sheet according to claim 6, wherein
a difference in thickness between the thickest portion and the thinnest portion along with width of the resin material is 1 mm or more with the shapes of the asperities transferred to said resin material.

27. The method of producing a resin sheet according to claim 9, wherein
a difference in thickness between the thickest portion and the thinnest portion along with width of the resin material is 1 mm or more with the shapes of the asperities transferred to said resin material.

28. The method of producing a resin sheet according to claim 6, wherein the thickness of the thinnest portion of said resin material is 5 mm or less.

29. The method of producing a resin sheet according to claim 9, wherein the thickness of the thinnest portion of said resin material is 5 mm or less.

30. The method of producing a resin sheet according to claim 15, wherein a difference in thickness between the thickest portion and the thinnest portion along the width of said resin material is 1 mm or more with the shapes of the asperities transferred to said resin material.

31. The method of producing a resin sheet according to claim 19, wherein
a difference in thickness between the thickest portion and the thinnest portion along the width of said resin material is 1 mm or more with the shapes of the asperities transferred to said resin material.

32. The method of producing a resin sheet according to claim 15, wherein the thickness of the thinnest portion of said resin material is 5 mm or less.

33. The method of producing a resin sheet according to claim 19, wherein the thickness of the thinnest portion of said resin material is 5 mm or less.
